(19) United States
(12) Patent Application Publication
(10) Pub. No.: US 2021/0349414 A1
(43) Pub. Date: Nov. 11, 2021

(54) IMAGE FORMING SYSTEM, IMAGE FORMING APPARATUS AND PROGRAM

(71) Applicant: Konica Minolta, Inc., Tokyo (JP)

(72) Inventor: HIROYUKI KONISHI, Tokyo (JP)

(21) Appl. No.: 17/242,161

(22) Filed: Apr. 27, 2021

(30) Foreign Application Priority Data
May 8, 2020 (JP) 2020-082569

(51) Int. Cl. G03G 15/00; G03G 21/20

(52) U.S. Cl. CPC G03G 15/55; G03G 21/203

(57) ABSTRACT

There is provided an image forming system that includes an image forming apparatus including an image former that forms an image on a recording material, the image forming system including: recording material storage enabled to store the recording material; a recording material supplier that supplies the recording material from the recording material storage to the image former; a recording material information detection apparatus that is arranged outside the image forming apparatus and detects recording material information of the recording material; and a hardware processor that determines whether or not the recording material detected by the recording material information detection apparatus is settable into the recording material storage on the basis of the recording material information detected by the recording material information detection apparatus and information preset for the recording material storage.

The entire disclosure of Japanese patent Application No. 2020-082569, filed on May 8, 2020, is incorporated herein by reference in its entirety.

### BACKGROUND

### Technological Field

The present invention relates to an image forming system, an image forming apparatus and a program.

### Description of the Related Art

An image forming apparatus has conventionally been operated in a workflow in which sheets are set (stored) in a sheet feeding tray, and a user performs setting of information (sheet type and basis weight) of the sheets set in the tray through an operation screen, and instructs an execution start of a job. There has been a demand for simplifying the operation to the image forming apparatus, and making the image forming apparatus adaptable to various types of sheets. Thus, a technology has come to be used that sets, as sheet information in the image forming apparatus, a result of measuring sheet information of a sheet conveyed on a sheet conveying path and a result of measuring a sheet used in the job, by an in-line media detection apparatus provided in the conveying path of the image forming apparatus.

In JP 2019-188627 A, a technology is disclosed in which, on the basis of a sheet profile set for the sheet feeding tray and a result of measuring a sheet set in the sheet feeding tray by an in-line media sensor, in the case of a mismatch, an image forming apparatus performs notification that the cause is a sheet setting error into the sheet feeding tray or a sheet profile setting error.

By the way, although there is a sheet feeding tray that is prohibited or unsuitable for sheet feeding depending on the sheet type or basis weight of the sheet, there has been a case where the user sets a sheet in the prohibited or unsuitable sheet feeding tray. After the sheet is set in the prohibited or unsuitable sheet feeding tray, a warning indicating that the sheet feeding tray is prohibited is displayed on the operation screen. Then, after the warning is displayed, the user had to set the sheet again in an appropriate sheet feeding tray and reset the sheet information. As described above, when the warning is displayed after setting of the sheet in the sheet feeding tray, it takes extra effort for the user.

### SUMMARY

The present invention has been made in view of such a situation, and an object of the present invention is to prevent extra effort from being taken when a recording material is set in recording material storage.

To achieve the abovementioned object, according to an aspect of the present invention, there is provided an image forming system that includes an image forming apparatus including an image former that forms an image on a recording material, and the image forming system reflecting one aspect of the present invention comprises: recording material storage enabled to store the recording material; a recording material supplier that supplies the recording material from the recording material storage to the image former; a recording material information detection apparatus that is arranged outside the image forming apparatus and detects recording material information of the recording material; and a hardware processor that determines whether or not the recording material detected by the recording material information detection apparatus is settable into the recording material storage on the basis of the recording material information detected by the recording material information detection apparatus and information preset for the recording material storage.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an overall configuration diagram of an image forming system according to a first embodiment of the present invention;

FIG. 2 is a block diagram illustrating an internal configuration example of each of apparatuses constituting the image forming system according to the first embodiment of the present invention;

FIG. 3 is an external perspective view illustrating a configuration example of a media detection apparatus according to the first embodiment of the present invention;

FIG. 4 is a block diagram illustrating a configuration example of a control unit according to the first embodiment of the present invention;

FIG. 5 is a diagram illustrating a configuration example of a sheet feeding tray availability determination table according to the first embodiment of the present invention;

FIG. 6 is a diagram illustrating a display example of a conventional operation screen;

FIG. 7 is a flowchart illustrating an example of a sheet feeding tray control method performed in the image forming system according to the first embodiment of the present invention:

FIG. 8 is a flowchart illustrating an example of processing in which a determiner according to the first embodiment of the present invention determines whether or not the sheet feeding tray can be used;

FIG. 9 is a diagram illustrating a display example of an operation screen according to the first embodiment of the present invention;

FIG. 10 is a flowchart illustrating an example of processing in which the determiner according to the first embodiment of the present invention monitors a lever state of the sheet feeding tray and determines whether or not the sheet feeding tray can be used;

FIG. 11 is a flowchart illustrating an example of processing using a tray opening and closing mechanism according to the first embodiment of the present invention;

FIG. 12 is a flowchart illustrating an example of processing in which the determiner according to the first embodiment of the present invention determines a setting direction of a special sheet into the sheet feeding tray;

FIG. 13 is a diagram illustrating a display example of a message instructing a user in the setting direction of the special sheet according to the first embodiment of the present invention;

FIG. 14 is a flowchart illustrating an example of processing in which the determiner according to the first embodiment of the present invention determines the front and back of the sheet set in the sheet feeding tray;

FIG. 15 is a diagram illustrating a display example of a message instructing the user in the front and back of the sheet set in the sheet feeding tray according to the first embodiment of the present invention;

FIG. 16 is a flowchart illustrating an example of processing in which the determiner according to the first embodiment of the present invention determines availability of a dehumidification function of the sheet feeding tray;

FIG. 17 is a flowchart illustrating a detailed example of processing in step S64 in FIG. 16;

FIG. 18 is a flowchart illustrating an example of processing in which the determiner according to the first embodiment of the present invention determines availability of the dehumidification function on the basis of sheet information;

FIG. 19 is a block diagram illustrating an internal configuration example of an image forming apparatus constituting an image forming system according to a second embodiment of the present invention; and

FIG. 20 is a flowchart illustrating an example of processing in which a determiner according to the second embodiment of the present invention determines whether or not the sheet feeding tray can be used after a start of printing.

### DETAILED DESCRIPTION OF EMBODIMENTS

Hereinafter, one or more embodiments of the present invention will be described with reference to the drawings. However, the scope of the invention is not limited to the disclosed embodiments. In the present specification and the drawings, components having substantially the same function or configuration will be denoted by the same reference numerals, and redundant descriptions will be omitted.

### First Embodiment

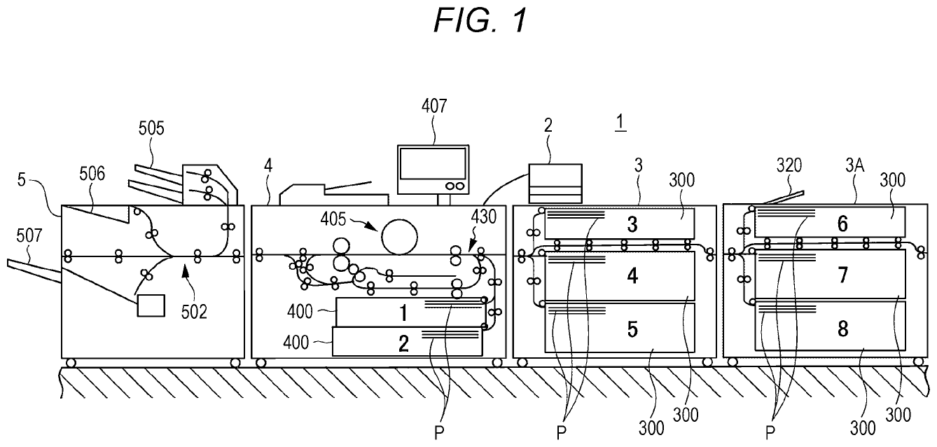

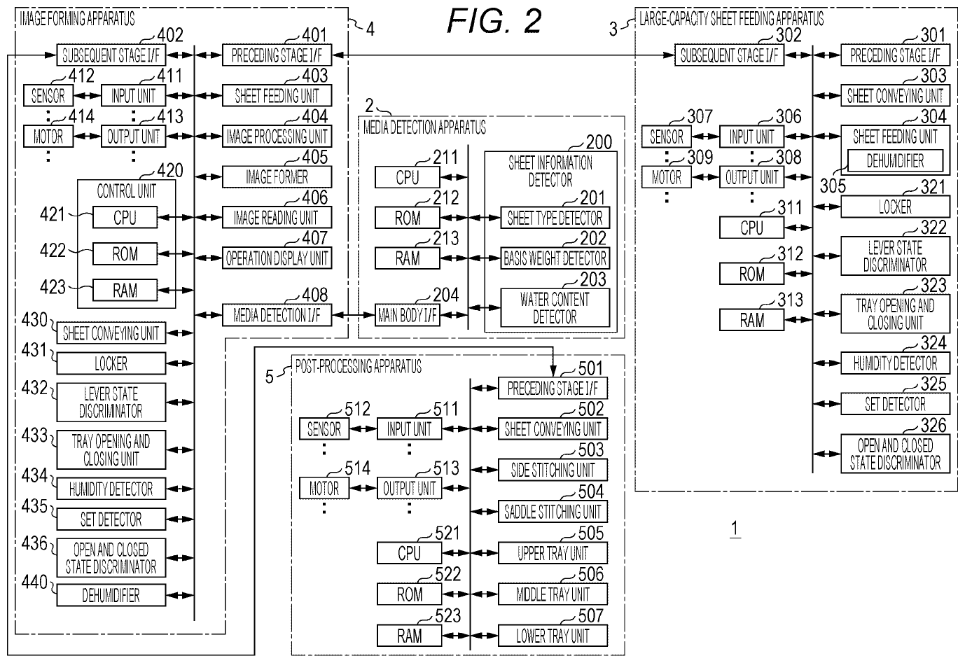

First, a configuration example of an image forming system according to a first embodiment of the present invention will be described with reference to FIGS. 1 and 2.

FIG. 1 is an overall configuration diagram of an image forming system 1.

FIG. 2 is a block diagram illustrating an internal configuration example of each of apparatuses constituting the image forming system 1.

The image forming system 1 includes a media detection apparatus 2, a large-capacity sheet feeding apparatuses 3 and 3A, an image forming apparatus 4, and a post-processing apparatus 5. The present embodiment has a configuration in which the image forming system 1 includes two large-capacity sheet feeding apparatuses 3 and 3A, but may have a configuration in which only one large-capacity sheet feeding apparatus 3 is included.

As illustrated in FIG. 1, the large-capacity sheet feeding apparatuses 3 and 3A each include three stages of sheet feeding trays 300 (examples of recording material storage). Each sheet feeding tray 300 can store a large number of sheets P (examples of a recording material, also referred to as “media”). Then, the sheet feeding tray 300 is connected to the image forming apparatus 4. The media detection apparatus 2 (an example of a recording material information detection apparatus) that detects sheet information of the sheet P is installed on the upper part of the large-capacity sheet feeding apparatus 3. Then, the large-capacity sheet feeding apparatuses 3 and 3A are connected to the image forming apparatus 4 so that the sheet P can be ejected. A manual feed tray 320 is provided on the upper part of the large-capacity sheet feeding apparatus 3A. When a user manually feeds several sheets P into the manual feed tray 320, the sheets P are conveyed in a conveying path in the order of the large-capacity sheet feeding apparatuses 3A and 3, and the image forming apparatus 4.

The media detection apparatus 2 is arranged outside the image forming apparatus 4, and is connected to the image forming apparatus 4 via a communication cable. Furthermore, the image forming apparatus 4 includes two stages of sheet feeding trays 400 (examples of the recording material storage). Each sheet feeding tray 400 can store the sheet P. The sheet feeding tray 400 is included in the image forming apparatus 4.

As illustrated in FIG. 1, sheet feeding tray numbers “1” to “8” are assigned so that the sheet feeding trays 300 and 400 can be identified. For this reason, in the following description, the sheet feeding trays 300 and 400 may be abbreviated as a sheet feeding tray 1, a sheet feeding tray 2, and the like in accordance with the sheet feeding tray number. Furthermore, when the sheet feeding trays 1 to 8 are not distinguished, they may be referred to only as “sheet feeding trays”. Furthermore, in the figure, an example is illustrated in which the sheets P are stored in all the sheet feeding trays, but whether or not the sheets P are stored in the sheet feeding trays is determined by determination processing described later.

<Configuration Example of Large-Capacity Sheet Feeding Apparatus>

Next, an internal configuration example of the large-capacity sheet feeding apparatus 3 will be described with reference to FIG. 2. However, since the large-capacity sheet feeding apparatuses 3 and 3A have the same configuration, in FIG. 2, an internal configuration example of the large-capacity sheet feeding apparatus 3 will be described by focusing only on the large-capacity sheet feeding apparatus 3.

The large-capacity sheet feeding apparatus 3 includes a preceding stage interface (I/F) 301, a subsequent stage I/F 302, a sheet conveying unit 303, a sheet feeding unit 304, a dehumidifier 305, input units 306, sensors 307, output units 308, and motors 309.

The preceding stage I/F 301 and the subsequent stage I/F 302 are communication interfaces that enable the plurality of large-capacity sheet feeding apparatuses 3 and 3A to communicate with each other. The preceding stage I/F 301 of the large-capacity sheet feeding apparatus 3 is connected to, for example, the subsequent stage I/F 302 of the large-capacity sheet feeding apparatus 3A via a communication cable. Furthermore, the subsequent stage I/F 302 of the large-capacity sheet feeding apparatus 3 is connected to a preceding stage I/F 401 of the image forming apparatus 4 via a communication cable.

The sheet conveying unit 303 conveys the sheet P stored in the sheet feeding tray 300 to the subsequent apparatus one by one. As illustrated in FIG. 1, the sheet P fed from the sheet feeding tray 300 of the large-capacity sheet feeding apparatuses 3 and 3A is conveyed to the subsequent device by the sheet conveying unit 303. In the present embodiment, an example will be described in which the sheet P is applied as the recording material, but the present embodiment is not limited to this, and various other materials such as a film and a cloth can be applied as the recording material.

The sheet feeding unit 304 (an example of a recording material supplier) feeds the sheet P from the sheet feeding tray 300 in which the sheet P is stored to an image former 405 via the sheet conveying unit 303. The sheet feeding unit 304 includes the dehumidifier 305. The dehumidifier 305 dehumidifies the sheet P stored in the sheet feeding tray 300. As the dehumidifier 305, for example, a heater, a fan, or the like is used. The sheet feeding tray provided with the dehumidifier 305 is treated as having a dehumidification function. However, in the present embodiment, there is also the sheet feeding unit 304 having a configuration in which the dehumidifier 305 is not provided.

Detection information is input to the input units 306 from the various sensors 307 installed in the large-capacity sheet feeding apparatus 3. The detection information is written in a Random Access Memory (RAM) 313, appropriately referred to by a Central Processing Unit (CPU) 311, and used for processing.

The output units 308 output drive instructions to the various motors 309 installed in the large-capacity sheet feeding apparatus 3. The motors 309 are driven, for example, under control of the sheet conveying unit 303, and take out the sheet P from the sheet feeding tray 300, and perform sheet conveyance.

Furthermore, the large-capacity sheet feeding apparatus 3 includes the CPU 311, a Read Only Memory (ROM) 312, and the RAM 313. The CPU 311 reads a program code of software that implements each of functions according to the present embodiment from the ROM 312, loads the program code into the RAM 313, and executes the program code. Variables, parameters, and the like generated during arithmetic processing by the CPU 311 are temporarily written in the RAM 313, and these variables, parameters, and the like are appropriately read by the CPU 311. As described above, the ROM 312 records a program, data, and the like necessary for the CPU 311 to operate, and is used as an example of a computer-readable non-transitory storage medium storing the program executed by a computer that operates the large-capacity sheet feeding apparatus 3.

Furthermore, the large-capacity sheet feeding apparatus 3 includes a locker 321, a lever state discriminator 322, a tray opening and closing unit 323, a humidity detector 324, a set detector 325, and an open and closed state discriminator 326 for each sheet feeding tray 300.

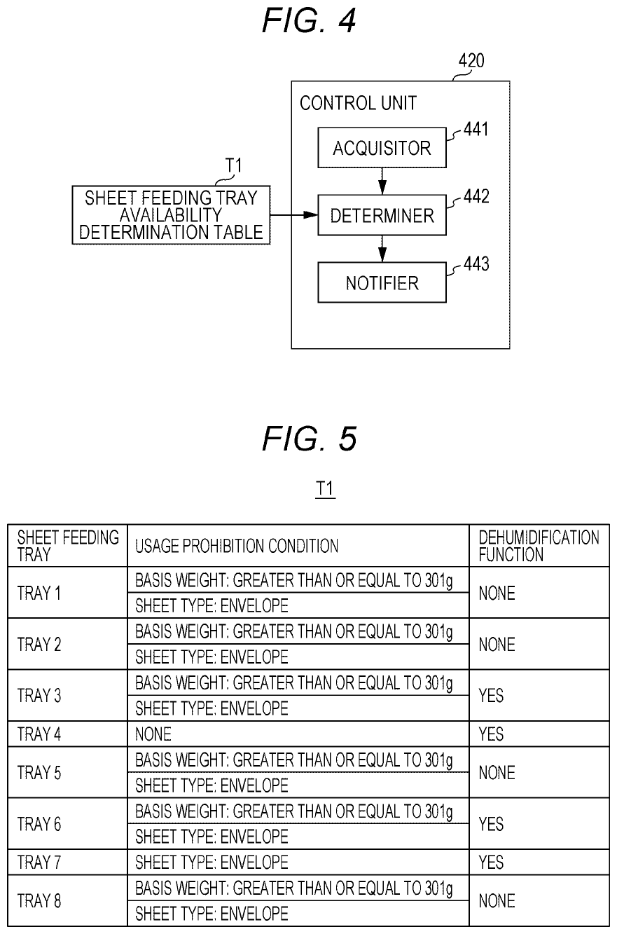

The locker 321 locks the sheet feeding tray 300 so that the sheet feeding tray 300 does not open. Locking by the locker 321 operates in accordance with an instruction from a control unit 420 (a determiner 442 illustrated in FIG. 4) of the image forming apparatus 4, but may operate in accordance with that a lever (not illustrated) that releases the locking by the locker 321 provided for each sheet feeding tray 300 is turned OFF.

The lever state discriminator 322 discriminates which state (referred to as “lever state”) the lever is in, ON or OFF, as a content of operation by the user. For example, when the user grips the lever and tries to release the locking, the lever state is ON, and when the user releases the lever and tries to perform locking, the lever state is OFF.

The tray opening and closing unit 323 opens and closes the sheet feeding tray 300 in auto-loading or the like. Note that, a tray opener may be provided that only performs operation of opening the sheet feeding tray 300. Both the tray opening and closing unit 323 and the tray opener are used as an example of a storage opener.

The humidity detector 324 detects humidity of the sheet P, the inside of the large-capacity sheet feeding apparatus 3, or an installation environment of the large-capacity sheet feeding apparatus 3.

The set detector 325 detects whether or not the sheet P is set in the sheet feeding tray 300, or detects whether or not the sheet P set in the sheet feeding tray 300 is in a correct direction.

The open and closed state discriminator 326 discriminates an open and closed state of the sheet feeding tray 300, which indicates whether the sheet feeding tray 300 is in an open state in which the sheet feeding tray 300 is opened or in a closed state in which the sheet feeding tray 300 is closed.

Information detected by the locker 321, the lever state discriminator 322, the tray opening and closing unit 323, the humidity detector 324, the set detector 325, and the open and closed state discriminator 326 is output to the CPU 311, and is further transmitted to the control unit 420 of the image forming apparatus 4.

<Configuration Example of Media Detection Apparatus>

Here, a configuration example of the media detection apparatus 2 will be described.

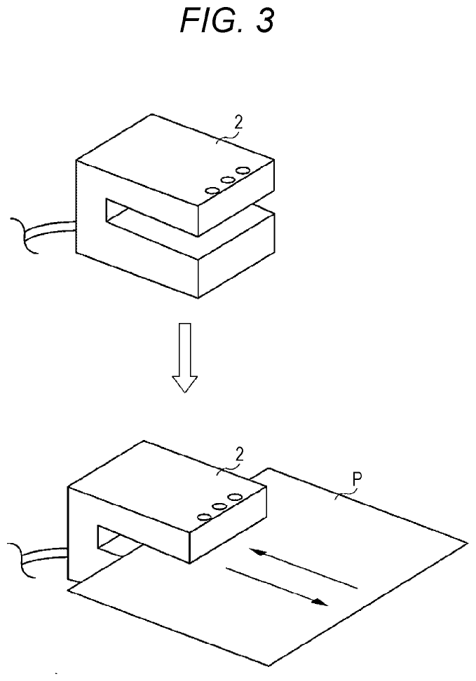

FIG. 3 is an external perspective view illustrating a configuration example of the media detection apparatus 2.

As illustrated in FIG. 1, a configuration is used in which the media detection apparatus 2 is installed outside the image forming apparatus 4, and is connected to the image forming apparatus 4 via a communication cable. The media detection apparatus 2 is further arranged outside the sheet feeding tray.

As illustrated on the upper side of FIG. 3, the media detection apparatus 2 has a cross-sectional shape of substantially U-shape. As described above, the media detection apparatus 2 includes a recess into which the user can insert at least a part of the sheet P.

Then, as illustrated on the lower side of FIG. 3, when the user inserts one side of the sheet P into the recess of the media detection apparatus 2, the media detection apparatus 2 detects sheet information (an example of recording material information) for the sheet P inserted into the recess. The media detection apparatus 2 detects a physical property value of the sheet P as the sheet information. The sheet P for Which the media detection apparatus 2 detects the sheet information is set in any of the sheet feeding trays 1 to 8 after the user causes the media detection apparatus 2 to detect the sheet information.

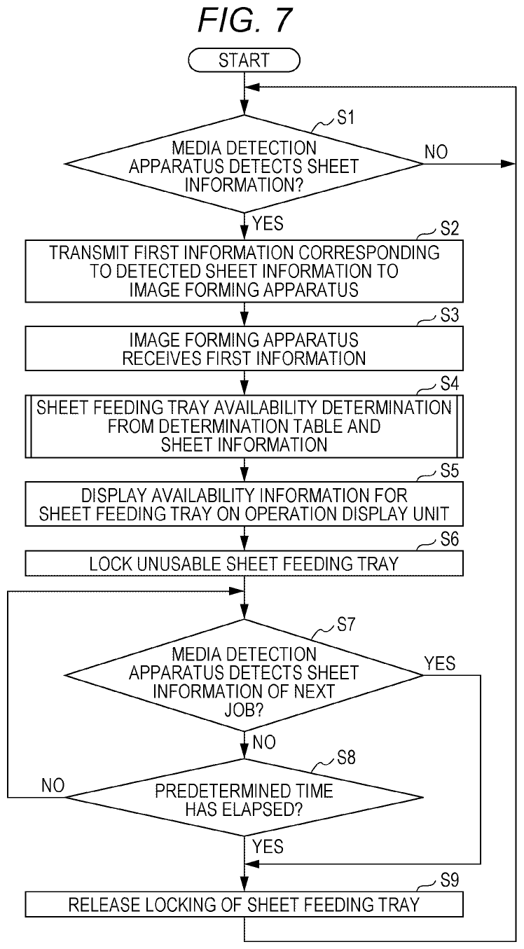

When the user puts the sheet P in and out of the media detection apparatus 2, the media detection apparatus 2 detects the sheet information of the sheet P. Then, the media detection apparatus 2 transmits first information corresponding to the sheet information to the image forming apparatus 4. The first information includes, for example, measured values obtained by measuring the physical properties of the sheet P such as a basis weight and a water content of the sheet P. Furthermore, the first information may include, for example, a sheet type of the sheet P such as that the sheet P is a thick sheet, and a detected value obtained by measuring the shape of the sheet P. Note that, as will be described later in FIG. 7, second information is also used in the present embodiment. The first information is information corresponding to the sheet information used in a job that the user causes the image forming apparatus 4 to execute this time. The second information is information corresponding to the sheet information used in a job that the user causes the image forming apparatus 4 to execute next time. Both the first information and the second information may be treated as information represented by a signal corresponding to the sheet information.

The media detection apparatus 2 transmits to the image forming apparatus 4 the first information obtained by reading an electrical value by a sensor (not illustrated) provided in the media detection apparatus 2. Then, the image forming apparatus 4 is formed to discriminate the sheet information such as the sheet type, the basis weight, and the water content of the sheet P on the basis of the first information received from the media detection apparatus 2.

Returning to FIG. 2 again, an internal configuration example of the media detection apparatus 2 will be described.

The media detection apparatus 2 includes a sheet information detector 200, a main body I/F 204, a CPU 211, a ROM 212, and a RAM 213.

The sheet information detector 200 (an example of a recording material information detector) detects the sheet information of the sheet P fed when the image forming apparatus 4 executes a job. The sheet information detector 200 includes a sheet type detector 201, a basis weight detector 202, and a water content detector 203.

The sheet type detector 201 detects the sheet type of the sheet P set in the sheet feeding tray 300 or 400.

The basis weight detector 202 detects the basis weight of the sheet P set in the sheet feeding tray 300 or 400.

The water content detector 203 detects the water content of the sheet P set in the sheet feeding tray 300 or 400.

The sheet type detected by the sheet type detector 201, the basis weight detected by the basis weight detector 202, and the water content detected by the water content detector 203 are all treated as the sheet information. The sheet information only needs to include at least one of the sheet type, the basis weight, or the water content.

The main body I/F 204 (an example of a first communicator) is connected to a media detection I/F 408 of the image forming apparatus 4 via a communication cable, and transmits the first information corresponding to the sheet information of the sheet P detected by the sheet information detector 200 to the image forming apparatus 4.

The CPU 211 reads a program code of software that implements each of functions according to the present embodiment from the ROM 212, loads the program code into the RAM 213, and executes the program code. Variables, parameters, and the like generated during arithmetic processing by the CPU 211 are temporarily written in the RAM 213, and these variables, parameters, and the like are appropriately read by the CPU 211. As described above, the ROM 212 records a program, data, and the like necessary for the CPU 211 to operate, and is used as an example of a computer-readable non-transitory storage medium storing the program executed by a computer that operates the media detection apparatus 2.

<Configuration Example of Image Forming Apparatus>

Next, an internal configuration example of the image forming apparatus 4 will be described.

The image forming apparatus 4 includes the preceding stage I/F 401, a subsequent stage I/F 402, a sheet feeding unit 403, an image processing unit 404, the image former 405, an image reading unit 406, an operation display unit 407, the media detection I/F 408, and a sheet conveying unit 430.

The preceding stage I/F 401 and the subsequent stage I/F 402 are communication interfaces that enable the image forming apparatus 4 to communicate with other devices. The preceding stage I/F 401 of the image forming apparatus 4 is connected to the subsequent stage I/F 302 of the large-capacity sheet feeding apparatus 3 via a communication cable. Furthermore, the subsequent stage I/F 402 of the image forming apparatus 4 is connected to a preceding stage I/F 501 of the post-processing apparatus 5 via a communication cable.

The sheet feeding unit 403 (an example of the recording material supplier) supplies the sheet P from the sheet feeding tray 400 in which the sheet P is stored to the image former 405 via the sheet conveying unit 430.

The image processing unit 404 performs predetermined image processing such as RIP processing on an image transmitted to the image forming apparatus 4 from a PC, a server, or the like (not illustrated).

The image former 405 forms an image on the sheet P conveyed by the sheet conveying unit 430, for example, by an electrophotographic method. The image former 405 also performs processing of fixing the image formed on the sheet P.

The image reading unit 406 scans the sheet P to scan the image fixed on the sheet P. For this reason, the image reading unit 406 is arranged after the image former 405. The image read by the image reading unit 406 is stored in a RAM 423 or stored in an external large-capacity storage device (not illustrated).

The operation display unit 407 is provided for the user to give a job execution instruction to the image forming system 1. The operation display unit 407 includes a touch panel display, and the user performs settings for the job, the job execution instruction, and the like while looking at an operation screen displayed on the operation display unit 407. The information given through the operation display unit 407 is input to a CPU 421. Furthermore, a result of processing performed by the CPU 421 is displayed on the operation display unit 407.

The media detection I/F 408 (an example of a second communicator) is connected to the main body I/F 204 of the media detection apparatus 2 via a communication cable, and receives the first information from the media detection apparatus 2.

As illustrated in a sheet feeding tray availability determination table T1 of FIG. 5 described later, the sheet feeding tray 400 (sheet feeding trays 1 and 2) according to the present embodiment does not have the dehumidification function. However, the image forming apparatus 4 may be provided with a dehumidifier 440 that dehumidifies the sheet P stored in the sheet feeding tray 400, and may be provided with a function of causing the dehumidifier 440 to dehumidify the sheet P in the sheet feeding tray 400. As the dehumidifier 440, for example, a heater, a fan, or the like is used. A sheet feeding tray provided with the dehumidifier 440 is treated as having the dehumidification function.

Furthermore, the image forming apparatus 4 includes input units 411, sensors 412, output units 413, and motors 414.

Detection information is input to the input units 411 from the various sensors 412 installed in the image forming apparatus 4. The detection information is written in the RAM 423, appropriately referred to by the CPU 421, and used for processing.

The output units 413 output drive instructions to the various motors 414 installed in the image forming apparatus 4. The motors 414 are driven, for example, under control of the image former 405, and convey the sheet P and rotate various drums.

Furthermore, the image forming apparatus 4 includes the control unit 420. The control unit 420 is configured by combining functions implemented by the CPU 421, a ROM 422, and the RAM 423. The CPU 421 reads a program code of software that implements each of functions according to the present embodiment from the ROM 422, loads the program code into the RAM 423, and executes the program code. Variables, parameters, and the like generated during arithmetic processing by the CPU 421 are temporarily written in the RAM 423, and these variables, parameters, and the like are appropriately read by the CPU 421. As described above, the ROM 422 records a program, data, and the like necessary for the CPU 421 to operate, and is used as an example of a computer-readable non-transitory storage medium storing the program executed by a computer that operates the image forming apparatus 4.

Furthermore, the image forming apparatus 4 includes a locker 431, a lever state discriminator 432, a tray opening and closing unit 433, a humidity detector 434, a set detector 435, and an open and closed state discriminator 436 for each sheet feeding tray 400.

The locker 431 locks the sheet feeding tray 400 so that the sheet feeding tray 400 does not open. Locking by the locker 431 operates in accordance with an instruction from the control unit 420 (the determiner 442 illustrated in FIG. 4), but may operate in accordance with that a lever (not illustrated) that releases the locking by the locker 431 provided for each sheet feeding tray 400 is turned OFF.

The lever state discriminator 432 discriminates a lever state of the lever.

The tray opening and closing unit 433 is a mechanism that opens and closes the sheet feeding tray 400 for auto-loading or the like. Note that, a tray opener may be provided that only performs operation of opening the sheet feeding tray 400. Both the tray opening and closing unit 433 and the tray opener are used as an example of the storage opener.

The humidity detector 434 detects the humidity of the sheet P, humidity in the image forming apparatus 4, or humidity of an installation environment of the image forming apparatus 4.

The set detector 435 detects whether or not the sheet P is set in the sheet feeding tray 400, or detects whether or not the sheet P set in the sheet feeding tray 400 is in a correct direction.

The open and closed state discriminator 436 discriminates an open and closed state of the sheet feeding tray 400, which indicates whether the sheet feeding tray 400 is in an open state in which the sheet feeding tray 400 is opened or in a closed state in which the sheet feeding tray 400 is closed.

Information detected by the locker 431, the lever state discriminator 432, the tray opening and closing unit 433, the humidity detector 434, the set detector 435, and the open and closed state discriminator 436 is output to the control unit 420.

<Configuration Example of Post-Processing Apparatus>

Next, an internal configuration example of the post-processing apparatus 5 will be described.

The post-processing apparatus 5 includes the preceding stage I/F 501, a sheet conveying unit 502, a side stitching unit 503, a saddle stitching unit 504, an upper tray unit 505, a middle tray unit 506, and a lower tray unit 507.

The preceding stage I/F 501 is a communication interface that enables the post-processing apparatus 5 to communicate with the image forming apparatus 4. The preceding stage I/F 501 is connected to the subsequent stage I/F 402 of the image forming apparatus 4 via a communication cable.

The sheet conveying unit 502 conveys the sheet P ejected from the image forming apparatus 4. The sheet P is conveyed to any of the upper tray unit 505, the middle tray unit 506, or the lower tray unit 507. Furthermore, various types of post-processing are performed during the conveyance of the sheet P.

The side stitching unit 503 performs side stitching of the sheets P as an example of the post-processing.

The saddle stitching unit 504 performs saddle stitching of the sheets P as an example of the post-processing.

The sheet P in which a printing defect has occurred is ejected to the upper tray unit 505 and the middle tray unit 506. An ejection destination of the sheet P changes depending on a type of the printing defect.

The sheet P with good printing is ejected to the lower tray unit 507.

Furthermore, the post-processing apparatus 5 includes input units 511, sensors 512, output units 513, and motors 514.

Detection information is input to the input units 511 from the various sensors 512 installed in the post-processing apparatus 5. The detection information is written in a RAM 523, appropriately referred to by a CPU 521, and used for processing.

The output units 513 output drive instructions to the various motors 514 installed in the post-processing apparatus 5. The motors 514 are driven, for example, under control of the sheet conveying unit 502, and convey the sheet P and drive the side stitching unit 503 and the saddle stitching unit 504.

Furthermore, the post-processing apparatus 5 includes the CPU 521, a ROM 522, and the RAM 523. The CPU 521 reads a program code of software that implements each of functions according to the present embodiment from the ROM 522, loads the program code into the RAM 523, and executes the program code. Variables, parameters, and the like generated during arithmetic processing by the CPU 521 are temporarily written in the RAM 523, and these variables, parameters, and the like are appropriately read by the CPU 521. As described above, the ROM 522 records a program, data, and the like necessary for the CPU 521 to operate, and is used as an example of a computer-readable non-transitory storage medium storing the program executed by a computer that operates the post-processing apparatus 5.

<Configuration Example of Control Unit>

Next, a configuration example of the control unit 420 included in the image forming apparatus 4 will be described.

FIG. 4 is a block diagram illustrating a configuration example of the control unit 420.

The control unit 420 includes an acquisitor 441, the determiner 442, and a notifier 443.

The acquisitor 441 acquires the sheet information from the media detection apparatus 2 and outputs the sheet information to the determiner 442.

The determiner 442 determines whether or not the sheet P detected by the media detection apparatus 2 is settable into a sheet feeding tray on the basis of the sheet information detected by the media detection apparatus 2 and acquired by the acquisitor 441, and information preset for the sheet feeding tray. At this time, the determiner 442 determines whether or not the sheet P detected by the media detection apparatus 2 is settable into the sheet feeding tray on the basis of the detected sheet information and a usage prohibition condition preset for the sheet feeding tray. The usage prohibition condition is set for each sheet feeding tray included in the recording material storage.

For this reason, the determiner 442 determines whether or not the sheet P detected by the sheet information detector 200 is settable into the sheet feeding tray on the basis of a combination of the sheet information corresponding to the first information received by the media detection I/F 408 from the media detection apparatus 2 and the information of the sheet feeding tray. Here, the determiner 442 determines whether or not the sheet P is settable into the sheet feeding tray by referring to the sheet feeding tray availability determination table T1 illustrated in FIG. 5 described later. Note that, the sheet information acquired by the acquisitor 441 from the media detection apparatus 2 is the same as the sheet information corresponding to the first information received by the media detection I/F 408. For this reason, the acquisitor 441 has a function of instructing the media detection I/F 408 to receive the first information from the media detection apparatus 2.

The notifier 443 notifies the user of a determination result of whether or not the sheet P is settable into the sheet feeding tray in accordance with an instruction from the determiner 442. Notification of the determination result to the user is performed, for example, by displaying a message on the operation screen of the operation display unit 407, but the notification may be performed by emitting a voice message through a speaker (not illustrated) provided in the image forming apparatus 4.

The notifier 443 performs notification of the information of the sheet feeding tray for which the determiner 442 has determined that the sheet P is settable into the sheet feeding tray. Furthermore, the notifier 443 can also perform notification of the information of the sheet feeding tray for which the determiner 442 has determined that the sheet P is not settable into the sheet feeding tray.

Note that, the sheet feeding tray determined as not settable is locked by the locker 321 or 431, whereby the user may be indirectly notified that the sheet feeding tray is unusable. In this case, the notification of the determination result to the user by the notifier 443 does not have to be performed.

Next, a configuration example of the sheet feeding tray availability determination table will be described.

FIG. 5 is a diagram illustrating a configuration example of the sheet feeding tray availability determination table T1.

The sheet feeding tray availability determination table T1 includes fields for the sheet feeding tray, the usage prohibition condition, and the dehumidification function. The sheet feeding tray availability determination table T1 is stored in the ROM 422 of the image forming apparatus 4, for example, but may be stored inside a large-capacity storage device such as an HDD of the image forming apparatus 4, and contents of the sheet feeding tray availability determination table T1 may be updated depending on types of the large-capacity sheet feeding apparatuses 3 and 3A connected to the image forming apparatus 4.

The sheet feeding tray field stores sheet feeding tray numbers for identifying the sheet feeding tray 400 of the image forming apparatus 4 and the sheet feeding tray 300 of the large-capacity sheet feeding apparatuses 3 and 3A (see FIG. 1). In FIG. 5, instead of the sheet feeding tray number, it is expressed like “tray 1” and “tray 2”.

In the usage prohibition condition field, the basis weight and sheet type of the settable sheet P are set for each sheet feeding tray. The usage prohibition condition for a sheet feeding tray 4 is “None”. For this reason, any type of the sheet P can be set in the sheet feeding tray 4.

In the dehumidification function field, presence or absence of the dehumidification function in the sheet feeding trays 1 to 8 is stored.

Then, the determiner 442 determines that the sheet feeding tray in which the sheet P cannot be set is prohibited, on the basis of the basis weight, the sheet type, the necessity of dehumidification, and the like of the sheet P.

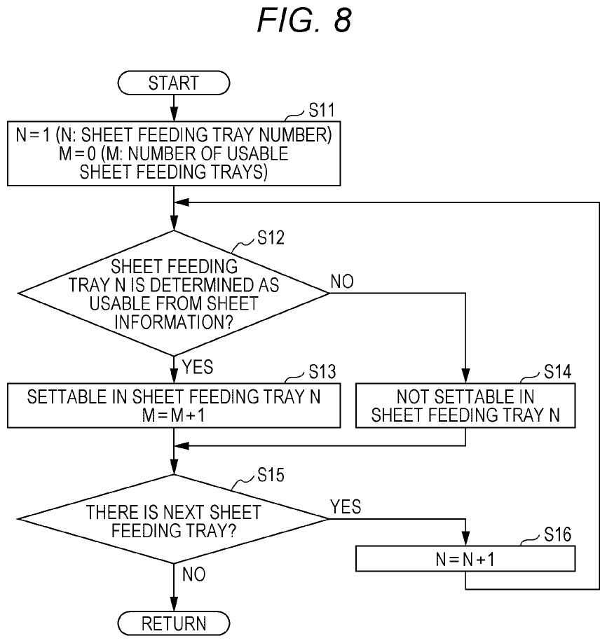

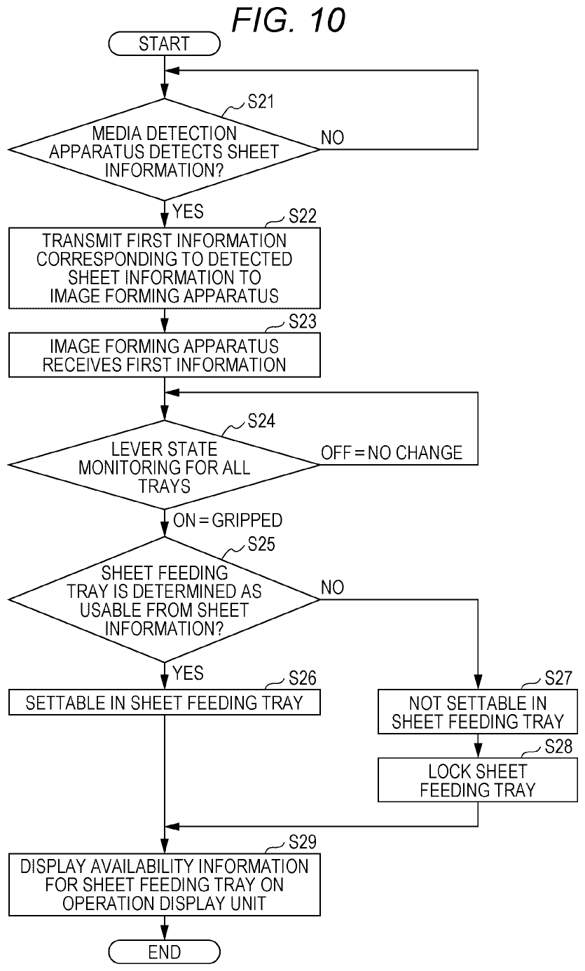

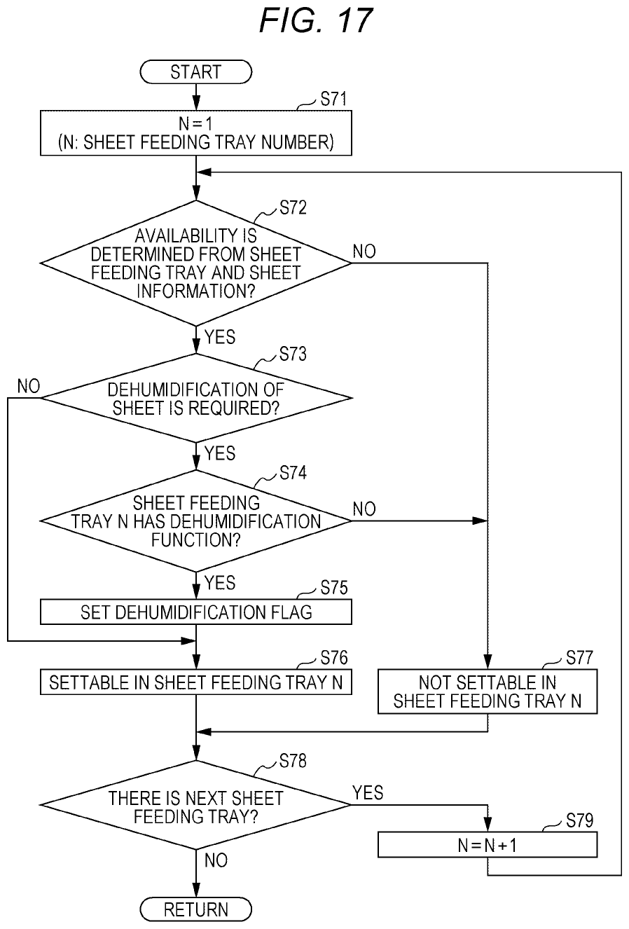

The sheet feeding tray availability determination table T1 is used for the determiner 442 to make prohibition determination in each processing steps described later (for example, step S12 in FIG. 8, step S25 in FIG. 10, and step S72 in FIG. 17). Note that, the sheet feeding tray availability determination table T1 is made to be used only for prohibition determination, but other than the prohibition, the sheet feeding tray availability determination table T1 may be made to be used for determination of whether the sheet P is suitable or not. The determination of whether the sheet P is suitable or not is used in, for example, a determination of being suitable or not based on a texture direction of the sheet P, in which setting of the sheet P into the sheet feeding tray is treated as unsuitable in a condition where a jam occurs or the sheet P tends to be damaged although sheet feeding is not impossible.

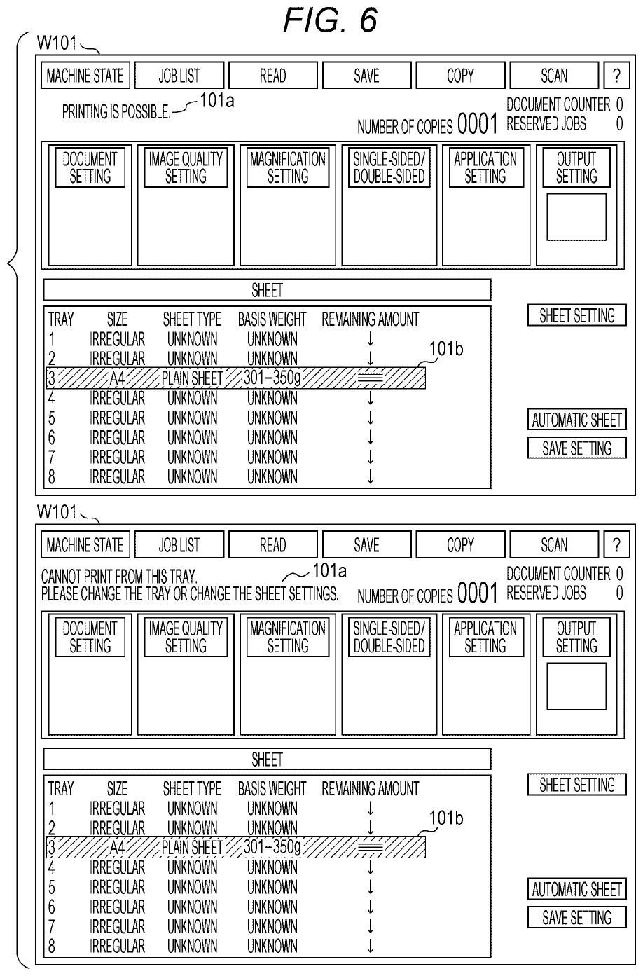

Here, a conventional setting procedure for the sheet P will be described with reference to FIG. 6. (1) If preparation of the image forming apparatus 4 is completed, “Printing is possible” is displayed in a message display field 101a of an operation screen W101 illustrated on the upper side of FIG. 6 before the sheet P is set. (2) Next, the user sets the sheet P in the sheet feeding tray 3 (the top sheet feeding tray of the large-capacity sheet feeding apparatus 3).

(3) Next, after the sheet P is set, one sheet of the sheet P is conveyed without image formation, and when information on the sheet type and the basis weight of the sheet P is detected by a sheet property detection sensor (in-line sensor) provided in the image forming apparatus 4, the information on the sheet type and the basis weight is set for the sheet feeding tray 3 in which the sheet P is set. For example, it is detected that a plain sheet (sheet P) of the size of A4 and a basis weight of 301-350 g is set in the sheet feeding tray 3.

(4) However, as indicated in the sheet feeding tray availability determination table T1, sheet feeding is not possible for the sheet P having a basis weight of greater than or equal to 301 g/m² in the sheet feeding tray 3. For this reason, even if the user inputs a job execution instruction after the sheet P is set in the sheet feeding tray 3, the job cannot be executed due to the prohibition. Thus, in the message display field 101a illustrated at the lower side of FIG. 6, “Cannot print from this tray. Please change the tray or change the sheet settings.” is displayed. (5) When confirming the message displayed in the message display field 101a, the user resets the sheet P in another sheet feeding tray (for example, the sheet feeding tray 4). After that, the user causes the job to be executed.

As described above, in the conventional setting procedure, when it is determined that the sheet feeding and setting of the sheet P are not possible after the user has set the sheet P in the sheet feeding tray, effort of resetting the sheet P in another sheet feeding tray has occurred. Thus, the image forming apparatus 4 according to the present embodiment performs control so that the sheet P is not set in the sheet feeding tray for which it is determined that the sheet feeding and setting of the sheet P are not possible.

A sheet feeding tray control method according to the present embodiment will be described with reference to FIGS. 7 and 8.

FIG. 7 is a flowchart illustrating an example of the sheet feeding tray control method performed in the image forming system 1.

First, the media detection apparatus 2 determines whether or not the sheet information of the sheet P is detected (S1). If the user does not put the sheet P to be set in the sheet feeding tray in and out of the recess of the media detection apparatus 2, the media detection apparatus 2 does not detect the sheet information of the sheet P (NO in S1), so that processing of step S1 is repeated until the sheet information is detected.

When detecting the sheet information of the sheet P (YES in S1), the media detection apparatus 2 transmits the first information corresponding to the sheet information of the detected sheet P to the image forming apparatus 4 (S2). The image forming apparatus 4 receives the first information from the media detection apparatus 2 (S3). That is, the acquisitor 441 of the image forming apparatus 4 acquires the sheet information corresponding to the first information.

For all the sheet feeding trays, the determiner 442 of the image forming apparatus 4 determines whether or not the sheet feeding tray can be used in accordance with the sheet feeding tray availability determination table T1 (abbreviated as “determination table” in the figure) for the sheet information corresponding to the received first information (S4). Details of processing in step S4 will be described with reference to FIG. 8. In the present embodiment, an example is given in which the determiner 442 determines availability (prohibition) for each sheet feeding tray, but depending on conditions, whether the sheet P is suitable or not for use may be used as a determination condition. For example, the determiner 442 may perform processing of determining whether the sheet P is suitable or not for use on the basis of the texture direction of the sheet P.

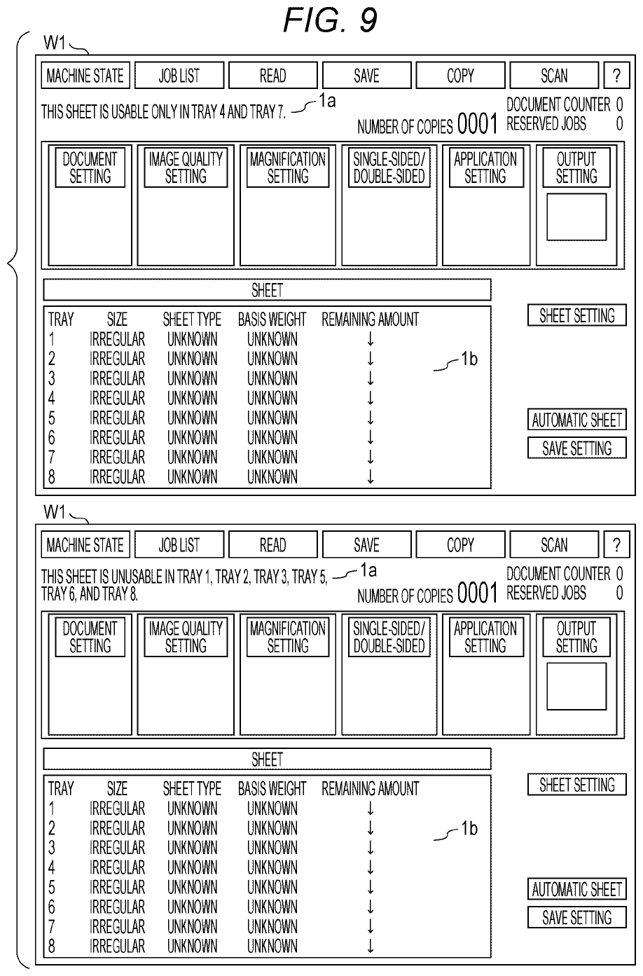

Next, the determiner 442 instructs the notifier 443 to perform notification of availability information (see FIG. 9 described later) of the sheet feeding tray determined as usable or unusable, and the notifier 443 displays the availability information of the sheet feeding tray on the operation display unit 407 (S5). In the present embodiment, a message is displayed on the operation display unit 407, whereby the user is notified of the availability information of the sheet feeding tray; however, a voice message may be emitted from a speaker, whereby the notification of the availability information of the sheet feeding tray may be performed.

In the large-capacity sheet feeding apparatus 3 not including the locker 321 and the image forming apparatus 4 not including the locker 431, the control method by the acquisitor 441, the determiner 442, and the notifier 443 according to the present embodiment holds even only the processing up to step S5.

Note that, in the large-capacity sheet feeding apparatus 3 including the locker 321 and the image forming apparatus 4 including the locker 431, the subsequent processing is performed.

After step S5, the determiner 442 causes the locker 321 or 431 provided for the sheet feeding tray for which it is determined that the sheet P is not settable into the sheet feeding tray to operate to lock the unusable sheet feeding tray (S6). The locker 321 or 431 locks the sheet feeding tray to prevent the unusable sheet feeding tray from opening.

Note that, normally, the lockers 321 and 431 are in a state of locking the sheet feeding trays, and when the lever provided for the sheet feeding tray is gripped by the user and the lever is turned ON, the locker 321 or 431 of the sheet feeding tray with the lever turned ON releases the locking. However, the determiner 442 may control the unusable sheet feeding tray so that the locking is not released even if the lever state discriminators 322 and 432 detect that the lever is turned ON.

Then, when the determiner 442 causes the locker 321 or 431 to operate to lock the sheet feeding tray and then the second information different from the first information is output from the sheet information detector 200, or a predetermined time has elapsed, the locking of the sheet feeding tray is released. For example, when the sheet P used in the next job is set in the sheet feeding tray, the sheet information of the sheet P used in the next job is detected by the media detection apparatus 2. If the second information corresponding to the sheet information of the sheet P used in the next job is different from the first information corresponding to the sheet information of the sheet P already set in the sheet feeding tray, the determiner 442 determines whether or not the sheet P used in the next job is settable. Thus, after step S6, the media detection apparatus 2 determines whether or not the sheet information of the sheet P used in the next job is detected (S7).

If the media detection apparatus 2 detects the sheet information of the sheet P used in the next job (YES in S7), there is a possibility that the sheet P used in the next job is set in the sheet feeding tray, so that the processing proceeds to step S9. Then, the sheet information of the sheet P used in the next job is transmitted as the second information, from the media detection apparatus 2 to the image forming apparatus 4.

On the other hand, when the media detection apparatus 2 does not detect the sheet information of the sheet P used in the next job (NO in S7), the media detection apparatus 2 determines whether or not the predetermined time has elapsed (S8). If the predetermined time has not elapsed (NO in S8), the processing returns to step S7.

On the other hand, if the predetermined time has elapsed (YES in S8), it is unlikely that the sheet P is set for which the media detection apparatus 2 has detected the sheet information after the time of processing in step S8, so that the processing proceeds to step S9.

After the NO determination in step S7 or the YES determination in step S8, the determiner 442 causes the locker 321 or 431 to operate to release the locking of the sheet feeding tray (S9). After that, the processing returns to step S1 and is repeated.

As described above, the processing illustrated in FIG. 7 may be ended after the processing of step S6. In this case, the unusable sheet feeding tray remains locked, but there is no possibility that the user accidentally opens the unusable sheet feeding tray. In this case, the processing may be skipped of displaying the availability information for the sheet feeding tray on the operation display unit 407 illustrated in step S5 in FIG. 7. For the user, even if the availability information for the sheet feeding tray is not displayed on the operation display unit 407, the sheet feeding tray that is unusable is locked, so that the sheet P can be set in the usable sheet feeding tray for which the locking is released.

Next, an example of detailed processing in step S4 will be described.

FIG. 8 is a flowchart illustrating an example of processing in which the determiner 442 determines whether or not the sheet feeding tray can be used.

First, the determiner 442 sets initial values in a sheet feeding tray number N and the number of sheet feeding trays M determined as usable (S11). Here, the determiner 442 sets the initial value of the sheet feeding tray number N to “1”, and sets the initial value of the number of sheet feeding trays M determined by the determiner 442 as usable to “0”. The sheet feeding tray number N, and the number of sheet feeding trays M determined by the determiner 442 as usable are both stored in the RAM 423. Note that, the maximum number of the sheet feeding tray number is “8” in the present embodiment.

Next, the determiner 442 refers to the sheet feeding tray availability determination table T1 and determines whether or not the sheet feeding tray number N is usable on the basis of the sheet information (S12). For example, when the sheet type is plain sheet and the basis weight is 301-350 g/m² as the sheet information, the basis weight set in the usage prohibition condition of the sheet feeding tray 1 is specified as greater than or equal to 301 g in the sheet feeding tray availability determination table T1, so that the sheet feeding tray 1 is unusable. On the other hand, the usage prohibition condition is not specified for the sheet feeding tray 4. For this reason, the determiner 442 determines that the sheet feeding tray 1 is unusable, and the sheet feeding tray 4 is usable.

When the sheet feeding tray number N is usable (YES in S12), the determiner 442 stores, in the RAM 423, information indicating that the sheet feeding tray with the sheet feeding tray number N is determined as usable. Furthermore, the determiner 442 counts up the number of sheet feeding trays M determined as usable by “1” (S13). Note that, the determiner 442 may store the sheet feeding tray number N determined as usable in the RAM 423.

On the other hand, when the sheet feeding tray number N is not usable (NO in S12), the determiner 442 stores, in the RAM 423, information indicating that the sheet feeding tray with the sheet feeding tray number N is determined as unusable (S14).

After steps S13 and S14, the determiner 442 determines whether or not there is a next sheet feeding tray (S15). In this determination, the determiner 442 determines whether or not the sheet feeding tray number N is less than the maximum number (8 in the embodiment) of sheet feeding trays. If there is no next sheet feeding tray (NO in S15), the determiner 442 returns the processing to step S5 in FIG. 7.

If there is the next sheet feeding tray (YES in S15), the determiner 442 counts up the sheet feeding tray number N by “1” (S16), returns to step S12, and continues the processing.

<Display Example of Operation Screen>

Next, a display example of the operation screen according to the first embodiment will be described with reference to FIG. 9.

FIG. 9 is a diagram illustrating a display example of an operation screen W1 according to the first embodiment. In addition to various items that can be set by the user, the operation screen W1 is provided with a message display field 1a and a sheet feeding tray display field 1b. Note that, in the present embodiment, since a message is displayed in the message display field 1a before the sheet P is set in the sheet feeding tray the information of the sheet P is not displayed in the sheet feeding tray display field 1b.

Here, a setting procedure for the sheet P according to the first embodiment will be described. (1) If preparation of the image forming apparatus 4 is completed, “Printing is possible” is displayed (not illustrated) in the message display field 1a of the operation screen W1 illustrated on the upper side of FIG. 9 before the sheet P is set. Thus, the user uses the media detection apparatus 2 to detect the sheet type and the basis weight of the sheet P to be set in the sheet feeding tray. The sheet type and the basis weight of the sheet P detected by the media detection apparatus 2 are transmitted to the image forming apparatus 4.

(2-1) Next, the notifier 443 displays a sheet feeding tray that is determined by the determiner 442 on the basis of the sheet type and the basis weight of the sheet P received from the media detection apparatus 2, and in which the sheet P is usable, on the operation screen W1 before the user sets the sheet P. In this case, “This sheet is usable only in tray 4 and tray 7.” is displayed in the message display field 1a of the operation screen W1 illustrated on the upper side of FIG. 9.

(2-2) However, the notifier 443 may display a sheet feeding tray that is determined by the determiner 442 on the basis of the sheet type and the basis weight of the sheet P received from the media detection apparatus 2, and in which the sheet P is unusable, on the operation screen W1 before the user sets the sheet P. In this case, in the message display field 1a of the operation screen W1 illustrated on the lower side of FIG. 9, “This sheet is unusable in tray 1, tray 2, tray 3, tray 5, tray 6, and tray 8.” is displayed.

Note that, messaging described in the procedures (2-1) and (2-2) may be carried out so that one or both of the messages are displayed in the message display field 1a.

(3) Next, the user sets the sheet P in the usable sheet feeding tray (for example, the sheet feeding tray 4) in accordance with the message displayed in the message display field 1a.

As described above, before the sheet P is set in the sheet feeding tray, the message that performs notification of the usable sheet feeding tray or the unusable sheet feeding tray is displayed in the message display field 1a. For this reason, effort does not have to be taken in which, as in the conventional case, if the user sets the sheet P in the sheet feeding tray once and then the sheet feeding tray is determined as unusable, the sheet P is reset in another sheet feeding tray. Furthermore, the user can easily find the usable sheet feeding tray in accordance with the message displayed in the message display field 1a, and can shorten the time until the sheet P is set.

Here, the image forming system 1 according to the present embodiment can perform various controls. Each control method will be described below

<Lever State Monitoring Processing>

FIG. 10 is a flowchart illustrating an example of processing in which the determiner 442 monitors the lever state of the sheet feeding tray and determines whether or not the sheet feeding tray can be used. However, since the processing in steps S21 to S23 in FIG. 10 is the same processing as that in steps S1 to S3 in FIG. 7, the description thereof will be omitted.

In this processing, the determiner 442 determines whether or not the sheet P detected by the sheet information detector 200 is settable into the sheet feeding tray on the basis of a combination of the sheet information corresponding to the first information input from the media detection apparatus 2 and the information of the sheet feeding tray from which the lever state indicating that the lever is gripped is output.

For example, after step S23, the determiner 442 monitors the lever states of all the sheet feeding trays (S24). The lever state monitoring is performed by the determiner 442 receiving a discrimination result from the lever state discriminators 322 and 432 provided on all the sheet feeding trays. When the lever states of all the sheet feeding trays remain OFF (OFF in S24), there is no change in the lever states, so that the determiner 442 continues the lever state monitoring in step S24.

If the lever state of any of the sheet feeding trays is ON (S24 is ON), the lever of any of the sheet feeding trays is gripped by the user. For this reason, the determiner 442 refers to the sheet feeding tray availability determination table T1 and determines whether or not the sheet feeding tray whose lever state is ON can be used on the basis of the sheet information (S25).

When it is determined that the sheet feeding tray whose lever state is ON is usable (YES in S25), the determiner 442 stores, in the RAM 423, information indicating that the sheet P is settable in the sheet feeding tray whose lever state is ON (S26).

On the other hand, when it is determined that the sheet feeding tray whose lever state is ON is not usable (NO in S25), the determiner 442 stores, in the RAM 423, information indicating that the sheet P is not settable in the sheet feeding tray whose lever state is ON (S27). Then, the determiner 442 causes the locker 321 of the sheet feeding tray determined as not settable to operate to lock the sheet feeding tray (S28). The locked sheet feeding tray cannot be opened by the user.

Then, after step S26 or S27, the determiner 442 displays the availability information of the sheet feeding tray for which the availability is determined on the operation display unit 407 as illustrated in FIG. 9 (S29), and ends this processing.

As described above, if the sheet feeding tray in which the user grips the lever and the lever state is ON is usable, the user can pull out the sheet feeding tray and set the sheet P in the sheet feeding tray. On the other hand, if the sheet feeding tray in which the user grips the lever is unusable, the sheet feeding tray is locked, so that the user cannot pull out the sheet feeding tray. For this reason, there is no possibility that the user sets the sheet P in the wrong sheet feeding tray.

<Processing Using Tray Opening and Closing Unit>

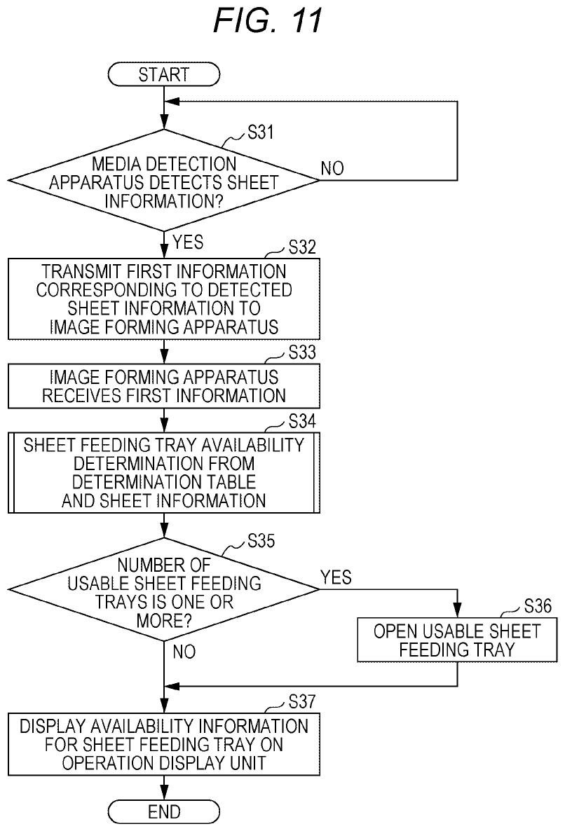

FIG. 11 is a flowchart illustrating an example of processing using the tray opening and closing units 323 and 433. However, since the processing in steps S31 to S34 in FIG. 11 is the same processing as that in steps S1 to S4 in FIG. 7, the description thereof will be omitted.

After step S34, the determiner 442 determines whether or not the number of usable sheet feeding trays M is one or more (S35). If the number of usable sheet feeding trays M is one or more (YES in S35), the usable sheet feeding tray is opened (S36). A plurality of types is assumed for the processing in step S36. For example, there is a method in which the determiner 442 outputs an instruction to release locking of the sheet feeding tray to the locker 321 or 431, the locker 321 or 431 releases the locking of the sheet feeding tray, and the user manually opens the sheet feeding tray. The number of sheet feeding trays of which the locker 321 or 431 releases the locking may be one or more.

Furthermore, the determiner 442 can also cause the tray opening and closing unit 323 or 433 provided on the sheet feeding tray for which it is determined that the sheet P is settable, to operate to automatically open the sheet feeding tray. At this time, the determiner 442 outputs an instruction to cause the tray opening and closing unit 323 or 433 corresponding to the sheet feeding tray for which it is determined that the sheet P is settable, to operate to open the sheet feeding tray. The tray opening and closing unit 323 or 433 to which the instruction from the determiner 442 is input opens the sheet feeding tray. The instruction output by the determiner 442 is given to one sheet feeding tray, but may be given to a plurality of sheet feeding trays.

Then, after determining that the number of usable sheet feeding trays M is less than one in step S35 (NO in S35) or opening the usable sheet feeding tray in step S36, the determiner 442 displays the availability information of the sheet feeding tray for which the availability is determined on the operation display unit 407 as illustrated in FIG. 9 (S37), and ends this processing.

As described above, if there is a sheet feeding tray usable for the sheet P, the sheet feeding tray opens. For this reason, the user only needs to set the sheet P in the opened sheet feeding tray.

<Processing of Determining Setting Direction of Special Sheet into Sheet Feeding Tray>

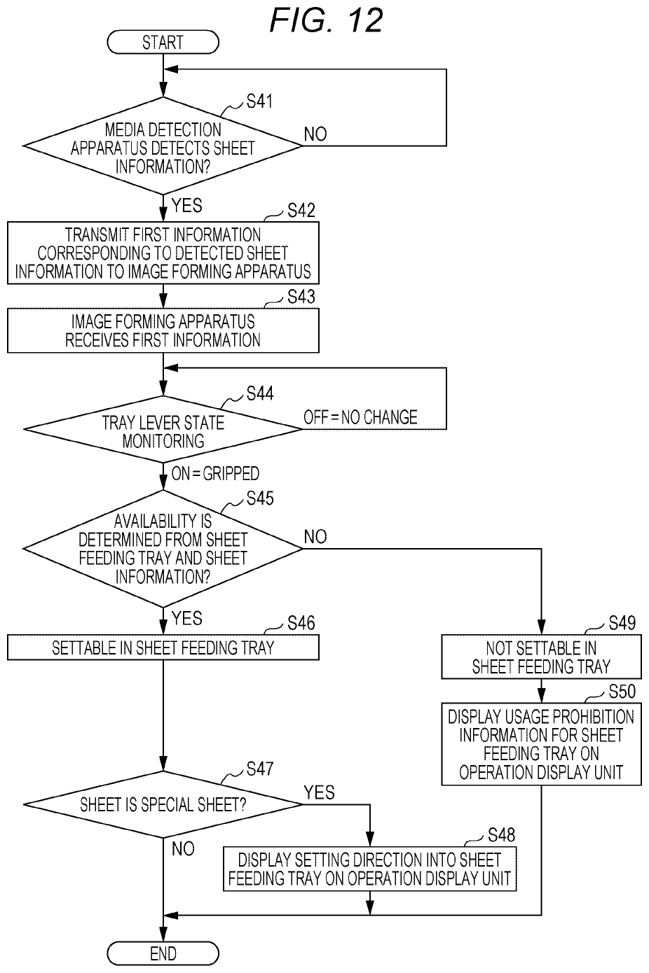

FIG. 12 is a flowchart illustrating an example of processing in which the determiner 442 determines a setting direction of a special sheet into the sheet feeding tray. However, since the processing in steps S41 to S43 in FIG. 12 is the same processing as that in steps S1 to S3 in FIG. 7, the description thereof will be omitted. Furthermore, since the processing in steps S44 to S46, and S49 in FIG. 12 is the same processing as that in steps S24 to S27 in FIG. 10, the description thereof will be omitted. Note that, the special sheet described below is the sheet P having a special shape such as a sheet whose sheet type is a tab sheet or an envelope sheet, coated sheet in which front and back surfaces have different paper qualities, and the like. The special sheet also includes the sheet P whose shapes of the front and rear with respect to the conveying direction are not symmetrical.

The sheet information includes information indicating that the sheet P is a special sheet. When the sheet information corresponding to the first information includes information indicating that the sheet is a special sheet, the determiner 442 determines whether or not the sheet P detected by the sheet information detector 200 is settable into the sheet feeding tray on the basis of a combination with the information of the sheet feeding tray from which the lever state indicating that the lever is gripped is output. Then, the determiner 442 causes the operation display unit 407 to perform notification of information indicating the setting direction of the sheet P into the sheet feeding tray for which it is determined that the sheet P is settable.

For example, after step S46, the determiner 442 determines whether or not the sheet P determined as settable in the sheet feeding tray is special sheet (S47). Furthermore, determination processing in step S47 is performed on the basis of the sheet information corresponding to the first information received from the media detection apparatus 2. Then, if the sheet P is not a special sheet (NO in S47), the determiner 442 ends this processing.

On the other hand, if the sheet P is a special sheet (YES in S47), the determiner 442 displays on the operation display unit 407 the setting direction of the sheet P into the sheet feeding tray (S48), and ends this processing. In step S48, for example, the setting direction into the sheet feeding tray is displayed on the operation display unit 407 for the sheet P whose front and rear are not symmetrical.

Furthermore, when the determiner 442 determines in step S45 that the sheet feeding tray is unusable (NO in S45), the determiner 442 determines that the sheet P is not settable in the sheet feeding tray determined as unusable (S49). For this reason, the determiner 442 displays usage prohibition information of the sheet feeding tray on the operation display unit 407 (S50) for the sheet P determined as not settable in the sheet feeding tray, and ends this processing.

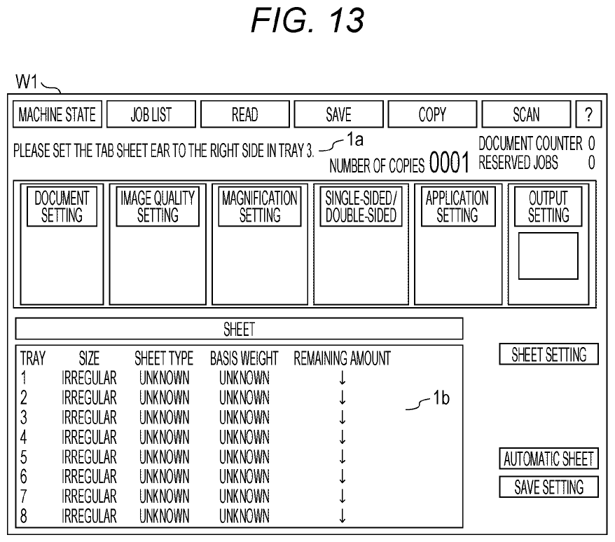

FIG. 13 is a diagram illustrating a display example of a message instructing the user in the setting direction of the special sheet.

An instruction in the setting direction of the sheet P determined as a special sheet in step S47 in FIG. 12 is given on the operation screen W1. For example, as an example of the special sheet, when the sheet P is determined as a tab sheet, in the message display field 1a of the operation screen W1 illustrated in FIG. 13. “Please set the tab sheet ear to the right side in tray 3.” is displayed. For this reason, the user can set the sheet P that is a tab sheet in the sheet feeding tray 3 in a correct setting direction.

Note that, when the sheet information corresponding to the first information includes information indicating a special sheet and it is discriminated by the open and closed state discriminator 326 that the sheet feeding tray is in the open state, the determiner 442 determines whether or not the sheet P detected by the sheet information detector 200 is settable into the sheet feeding tray on the basis of a combination with the information of the sheet feeding tray from which the lever state indicating that the lever is gripped is output. Then, the determiner 442 may cause the notifier 443 to perform notification of the information indicating the setting direction of the sheet P into the sheet feeding tray. In this case, the notifier 443 outputs the information indicating the setting direction of the sheet P into the sheet feeding tray to the operation display unit 407.

<Processing of Determining Front and Back of Sheet to be Set in Sheet Feeding Tray>

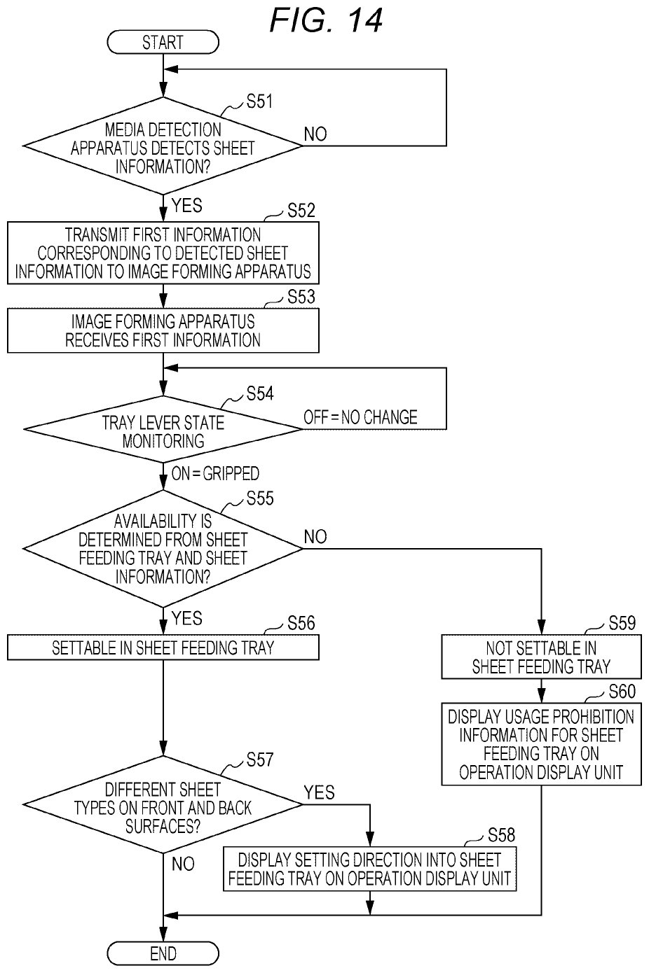

FIG. 14 is a flowchart illustrating an example of processing in which the determiner 442 determines the front and back of the sheet P set in the sheet feeding tray. However, since the processing in steps S51 to S53 in FIG. 14 is the same processing as that in steps S1 to S3 in FIG. 7, the description thereof will be omitted. Furthermore, since the processing in steps S54 to S56, and S59 in FIG. 14 is the same processing as that in steps S24 to S27 in FIG. 10, the description thereof will be omitted.

The sheet information includes information on the front surface and the back surface of the sheet P. When the sheet information corresponding to the first information includes information indicating a special sheet and the front surface and the back surface of the sheet P, the determiner 442 determines whether or not the sheet P detected by the sheet information detector 200 is settable into the sheet feeding tray on the basis of a combination with the information of the sheet feeding tray from which the lever state indicating that the lever is gripped is output. Then, the determiner 442 causes the operation display unit 407 to perform notification of information indicating the setting direction of the front surface or the back surface of the sheet P into the sheet feeding tray for which it is determined that the sheet P is settable.

After step S56, the determiner 442 determines whether or not the sheet P determined as settable in the sheet feeding tray has different sheet types on the front and back surfaces (S57). For example, the sheet P whose front surface is a coated sheet and whose back surface is a plain sheet is determined as having different sheet types on the front and back surfaces. When the sheet P does not have different sheet types on the front and back surfaces (NO in S57), the determiner 442 ends this processing.

On the other hand, when the sheet P has different sheet types on the front and back surfaces (YES in S57), the determiner 442 displays on the operation display unit 407 a message performing notification of the setting direction of the sheet P into the sheet feeding tray (S58), and ends this processing.

Furthermore, when the determiner 442 determines in step S55 that the sheet feeding tray is unusable (NO in S55), the determiner 442 determines that the sheet P is not settable in the sheet feeding tray determined as unusable (S59). For this reason, the determiner 442 displays usage prohibition information of the sheet feeding tray on the operation display unit 407 (S60) for the sheet P determined as not settable in the sheet feeding tray, and ends this processing.

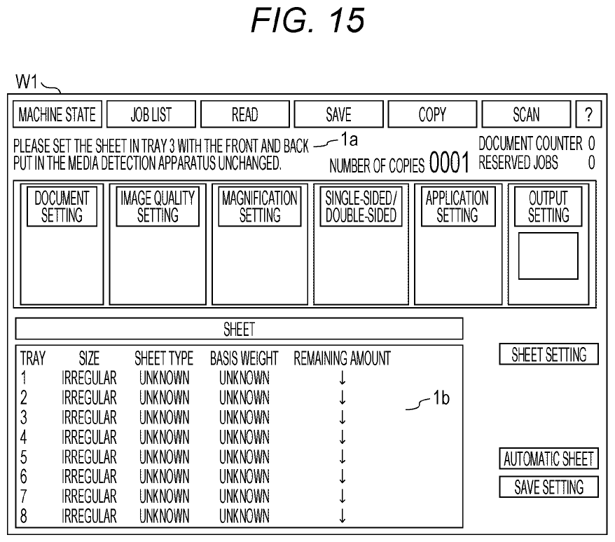

FIG. 15 is a diagram illustrating a display example of a message instructing the user in the front and back of the sheet P set in the sheet feeding tray.

For the sheet P determined as having different sheet types on the front and back surfaces in step S57 in FIG. 14, an instruction in the setting direction is given. Thus, in the message display field 1a of the operation screen W1 illustrated in FIG. 15, “Please set the sheet in tray 3 with the front and back put in the media detection apparatus unchanged.” is displayed. For this reason, the user can set the sheet in the sheet feeding tray 3 in the correct setting direction without changing the front and back of the sheet P having different sheet types on the front and back surfaces.

Note that, when the user sets the sheet P in the sheet feeding trays 1 and 2 provided in the image forming apparatus 4, in the message display field 1a, “Please reverse the front and back of the sheet P put in the media detection apparatus and set it in tray 1” is displayed. The reason for this is that, regarding the sheet feeding trays 1 and 2 provided in the image forming apparatus 4, unlike the sheet feeding trays 3 to 8 provided in the large-capacity sheet feeding apparatus 3, the front and back are reversed during the conveyance after feeding of the sheet P. There are known techniques regarding a method for sheet type setting for each of the front and back surfaces and a method for reflecting the sheet type setting in the image formation control when the front and back surfaces of the sheet P have different sheet types, so that details of the processing will be omitted.

Furthermore, when the sheet information corresponding to the first information includes information indicating a special sheet and the front surface and the back surface of the sheet P, and it is discriminated by the open and closed state discriminator 326 that the sheet feeding tray is in the open state, the determiner 442 determines whether or not the sheet P detected by the sheet information detector 200 is settable into the sheet feeding tray on the basis of a combination with the information of the sheet feeding tray from which the lever state indicating that the lever is gripped is output. Then, the determiner 442 may cause the operation display unit 407 to perform notification of the information indicating the setting direction of the sheet P into the sheet feeding tray.

<Determination of Availability of Dehumidification Function of Sheet Feeding Tray>

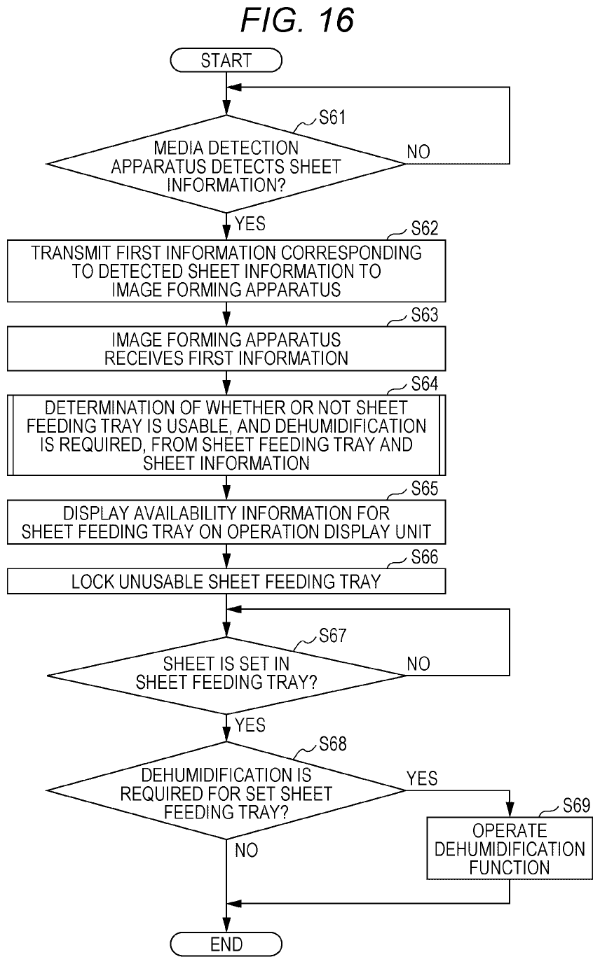

FIG. 16 is a flowchart illustrating an example of processing in which the determiner 442 determines availability of the dehumidification function of the sheet feeding tray. However, since the processing in steps S61 to 563 in FIG. 16 is the same processing as that in steps S1 to S3 in FIG. 7, the description thereof will be omitted.

After step S63, for all the sheet feeding trays, the determiner 442 determines whether or not the sheet feeding tray can be used, and further determines whether or not the dehumidification function is required (S64). The processing in which the determiner 442 determines, for all the sheet feeding trays, whether or not the sheet feeding tray can be used is the same as the processing of step S4 in FIG. 7. Furthermore, details of processing of determining whether or not the dehumidification function is required in step S64 will be described with reference to FIG. 17 described later.

Next, the determiner 442 displays the availability information of the sheet feeding tray for which the availability is determined on the operation display unit 407 as illustrated in FIG. 9 (S65), and causes the lockers 321 and 431 to operate to lock the unusable sheet feeding trays (S66).

Next, the determiner 442 determines whether or not the sheet P is set in the sheet feeding tray (S67). If the sheet P is not set (NO in S67), the determiner 442 repeats the processing of step S67 until the sheet P is set.

On the other hand, if the sheet P is set (YES in S67), the determiner 442 determines whether or not the sheet feeding tray in which the sheet P is set requires dehumidification (S68). Whether or not dehumidification is required is determined by whether or not a dehumidification flag is set in FIG. 17 described later. If the dehumidification flag is not set and dehumidification is not required (NO in S68), the determiner 442 ends this processing.

On the other hand, if the dehumidification flag is set and dehumidification is required (YES in S68), the determiner 442 causes the dehumidifier 305 of the sheet feeding tray in which the sheet P is set to operate the dehumidification function (S69), and ends this processing. Here, in step S69, when determining that dehumidification of the sheet P is required on the basis of the sheet information corresponding to the first information input from the media detection apparatus 2, the determiner 442 causes the notifier 443 to perform notification of the information of the sheet feeding tray provided with the dehumidifier 305. The notifier 443 outputs the information of the sheet feeding tray provided with the dehumidifier 305 to the operation display unit 407.

FIG. 17 is a flowchart illustrating a detailed example of the processing in step S64 in FIG. 16. However, since the processing in steps S71 and S72 in FIG. 17 is the same processing as that in steps S11 and S12 in FIG. 8, the description thereof will be omitted.

After step S72, the determiner 442 determines whether or not the dehumidification of the sheet P is required (S73). If the dehumidification of the sheet P is required (YES in S73), the determiner 442 determines whether or not the sheet feeding tray N has the dehumidification function (S74).

If the sheet feeding tray N has the dehumidification function (YES in S74), the determiner 442 sets the dehumidification flag (S75). The dehumidification flag is a flag for which an area is secured in the RAM 423, and “0” is set as an initial value. For example, when the dehumidification flag is set, “1” is set in this area. If the dehumidification flag is not set, “0” remains set in this area.

If the dehumidification of the sheet P is not required (NO in S73), or after the dehumidification flag is set in step S75, the determiner 442 determines that the sheet P is settable in the sheet feeding tray N (S76). On the other hand, when it is determined in step S72 that the sheet feeding tray N is unusable (NO in S72), or when it is determined in step S74 that the sheet feeding tray N does not have the dehumidification function (NO in S74), the determiner 442 determines that the sheet P is not settable in the sheet feeding tray N (S77). Then, the determiner 442 stores, in the RAM 423, information indicating that the determination tray of the sheet feeding tray number N is determined as unusable.

After steps S76 and S77, the determiner 442 determines whether or not there is a next sheet feeding tray (S78). If there is no next sheet feeding tray (NO in S78), the determiner 442 returns the processing to step S65 in FIG. 16.

If there is a next sheet feeding tray (YES in S78), the determiner 442 counts up the sheet feeding tray number N by “1” (S79), returns to step S72, and continues the processing.

As described above, if the humidity of the sheet P, humidity in the image forming system 1, or humidity in the installation environment is high, an instruction is given to set the sheet P into the sheet feeding tray capable of operating the dehumidification function. Then, the determiner 442 operates the dehumidification function before feeding the sheet, so that the sheet P is dehumidified. For this reason, image formation onto the sheet P is performed well.

<Determination of Availability of Dehumidification Function Based on Sheet Information>

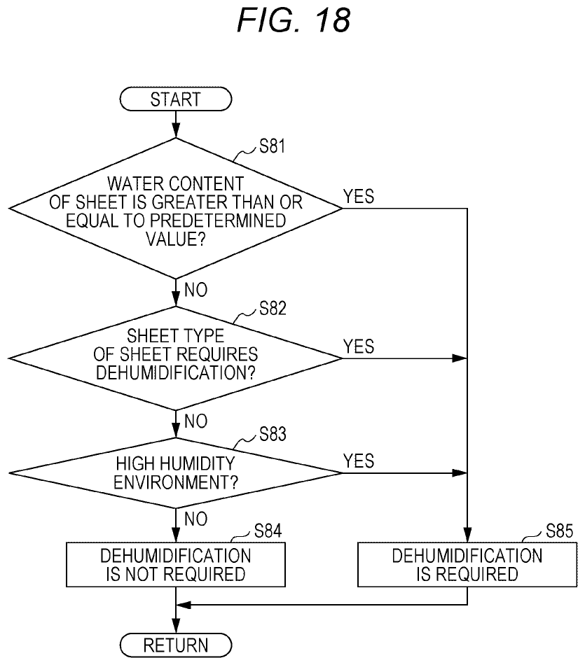

FIG. 18 is a flowchart illustrating an example of processing in which the determiner 442 determines availability of the dehumidification function on the basis of the sheet information. FIG. 18 illustrates details of the processing in which the determiner 442 determines whether or not the dehumidification of the sheet P is required in step S73 in FIG. 17.

In this processing, it is assumed that the first information includes information regarding the water content of the sheet P. For this reason, when determining that the water content of the sheet P is greater than or equal to a predetermined value on the basis of the first information, the determiner 442 causes the notifier 443 to perform notification of the information of the sheet feeding tray provided with the dehumidifier 305. The notifier 443 outputs the information of the sheet feeding tray provided with the dehumidifier 305 to the operation display unit 407.

For example, first, the determiner 442 determines whether or not the water content of the sheet P is greater than or equal to the predetermined value (for example, the water content is greater than or equal to 10%) on the basis of the sheet information corresponding to the first information received from the media detection apparatus 2 (S81). If the water content of the sheet P is greater than or equal to the predetermined value (YES in S81), the determiner 442 determines that the dehumidification of the sheet P is required (S85).

On the other hand, if the water content of the sheet P is less than the predetermined value (NO in S81), the determiner 442 determines whether or not the sheet type of the sheet P is a sheet type that requires dehumidification (for example, coated sheet) on the basis of the sheet information (S82). If the sheet type of the sheet P is a sheet type that requires dehumidification (YES in S82), the determiner 442 determines that the dehumidification of the sheet P is required (S85).

On the other hand, if the sheet type of the sheet P is not a sheet type that requires dehumidification (NO in S82), the determiner 442 determines whether or not humidity detected by the humidity detector 324 of the large-capacity sheet feeding apparatus 3 or the humidity detector 434 of the image forming apparatus 4 is that of a high humidity environment with a humidity of greater than or equal to a predetermined value (for example, humidity is greater than or equal to 50%) (S83). Here, the humidity detector 324 detects the humidity in the large-capacity sheet feeding apparatus 3 or the humidity in the installation environment of the large-capacity sheet feeding apparatus 3. Similarly, the humidity detector 434 detects the humidity in the image forming apparatus 4 or the humidity in the installation environment of the image forming apparatus 4.

If the humidity in the apparatus is greater than or equal to a predetermined value (YES in S83), the determiner 442 determines that the dehumidification of the sheet P is required (S85). For this reason, the determiner 442 causes the notifier 443 to perform notification of the information of the sheet feeding tray 300 provided with the dehumidifier 305. The notifier 443 outputs the information of the sheet feeding tray 300 provided with the dehumidifier 305 to the operation display unit 407. Furthermore, if the image forming apparatus 4 is provided with the dehumidifier 440, the determiner 442 causes the notifier 443 to perform notification of the information of the sheet feeding tray 400 provided with the dehumidifier 440. The notifier 443 outputs the information of the sheet feeding tray 400 provided with the dehumidifier 440 to the operation display unit 407.

On the other hand, if the humidity in the apparatus is less than the predetermined value (NO in S83), the determiner 442 determines that the dehumidification of the sheet P is not required (S84). After step S84 or S85, the determiner 442 returns to step S73 in FIG. 17 and determines whether or not the dehumidification of the sheet P is required, on the basis of a determination result of whether or not the dehumidification is required.

Note that, when the set detector 325 detects that the sheet P is set, the determiner 442 may cause the dehumidifier 305 of the sheet feeding tray provided with the set detector 325 to operate to dehumidify the sheet P, regardless of the necessity of the dehumidification function. Furthermore, when the image forming apparatus 4 is provided with the dehumidifier 440, when the set detector 435 detects that the sheet P is set, the determiner 442 may cause the dehumidifier 440 of the sheet feeding tray provided with the set detecting unit 435 to operate to dehumidify the sheet P.

### Second Embodiment

Next, an image forming apparatus 4A according to a second embodiment of the present invention will be described. The image forming apparatus 4A according to the present embodiment has a configuration in which the sheet information detector 200 is included. Then, the sheet information detector 200 detects the sheet information of the sheet P inserted from the manual feed tray 320 provided on the upper part of the large-capacity sheet feeding apparatus 3A.

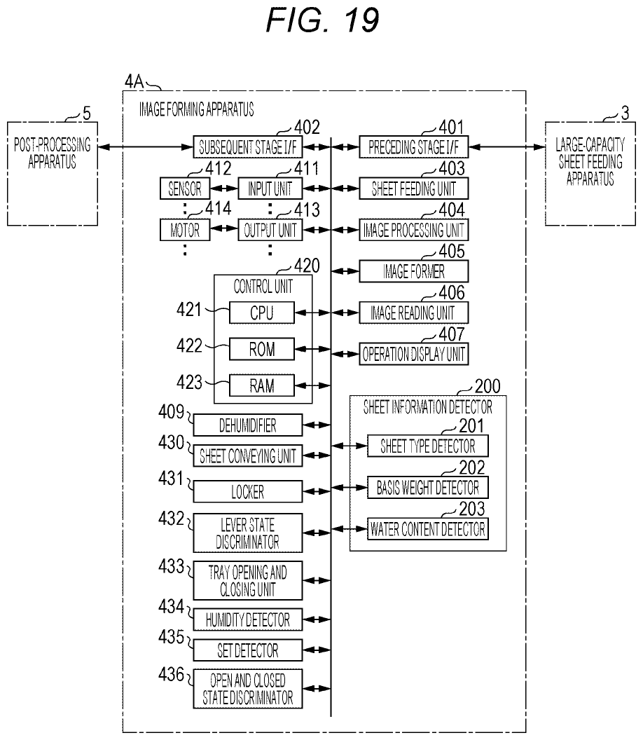

FIG. 19 is a block diagram illustrating an internal configuration example of the image forming apparatus 4A according to the second embodiment.

The image forming apparatus 4A includes the sheet information detector 200 in the housing of the image forming apparatus 4A as an in-line sensor provided in the conveying path (sheet conveying unit 430 in FIG. 1) of the sheet P. The sheet information detector 200 includes the sheet type detector 201, the basis weight detector 202, and the water content detector 203.

In the present embodiment, to cause the sheet information detector 200 to detect the sheet information of the sheet P, for example, the user performs a setting change of an operation mode of the image forming apparatus 4A from a normal job print mode to a sheet information detection mode through the operation display unit 407. In the sheet information detection mode, before the sheet P is actually set in the sheet feeding tray 400, one to several sheets P manually fed by the user from the manual feed tray 320 are conveyed into the image forming apparatus 4. Then, the sheet information detector 200 detects the sheet information of the conveyed sheet P.

Information including at least one of the sheet type of the sheet P detected by the sheet type detector 201 included in the sheet information detector 200, the basis weight of the sheet P detected by the basis weight detector 202, or the water content of the sheet P detected by the water content detector 203 is output to the control unit 420 as the first information corresponding to the sheet information. The determiner 442 of the control unit 420 performs predetermined determination on the basis of the sheet information corresponding to the first information input from the sheet information detector 200, and the notifier 443 outputs various types of information to the operation display unit 407 in accordance with an instruction of the determiner 442. Note that, in the present embodiment, the determiner 442 receives various types of information from the dehumidifier 440, the locker 431, the lever state discriminator 432, the tray opening and closing unit 433, the humidity detector 434, the set detector 435, and the open and closed state discriminator 436; and gives operation instructions to them, similarly to the determiner 442 of the image forming apparatus 4 according to the first embodiment.

<Processing of Determining Whether or not Sheet Feeding Tray can be Used after Start of Printing>

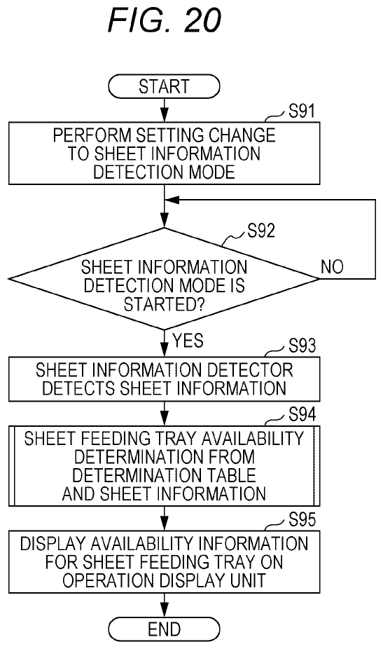

FIG. 20 is a flowchart illustrating an example of processing in which the determiner 442 determines whether or not the sheet feeding tray can be used after a start of printing.

First, the user performs a setting change of the operation mode from the normal job print mode to the sheet information detection mode through the operation display unit 407 (S91). Next, the determiner 442 determines whether or not the user inputs an instruction to start the sheet information detection mode through the operation display unit 407 (S92). When the user places several sheets P on the manual feed tray 320 and then presses a start button through the operation display unit 407, the sheet information detection mode is started. For this reason; if the instruction to start the sheet information detection mode is not input (NO in S92); the determiner 442 repeats the determination in step S92.

On the other hand, when the instruction to start the sheet information detection mode is input (YES in S92), the sheet information detector 200 provided in the image forming apparatus 4 detects the sheet information of the sheet P conveyed from the manual feed tray 320 (S93). Since the sheet information detector 200 is provided inside the image forming apparatus 4, the sheet information of the sheet P conveyed by the sheet conveying unit 430 of the image forming apparatus 4 is detected, and the first information is output to the determiner 442.

Next, the determiner 442 determines, for all the sheet feeding trays, whether or not the sheet feeding tray can be used, in accordance with the sheet feeding tray availability determination table T1, for the sheet information corresponding to the first information input from the sheet information detector 200 (S94). The processing of step S94 is the same as the processing of step S4 in FIG. 7 and each step in FIG. 8.

After step S94, the determiner 442 displays the availability information (see FIG. 9) of the sheet feeding tray determined as usable or unusable on the operation display unit 407 (S95), and ends this processing.

In this image forming system 1, the sheet information detector 200 is provided inside the image forming apparatus 4. For example, due to the user performing a setting change to the sheet information detection mode, the sheet information detector 200 detects the sheet information of the sheet P to be set in the sheet feeding tray before the sheet P is actually set in the sheet feeding tray. Then, the availability information of the sheet feeding tray in which the sheet P is settable is displayed on the operation display unit 407. For this reason, the user can set the sheet P in the sheet feeding tray determined as usable on the basis of the displayed availability information of the sheet feeding tray.

Note that, in the first and second embodiments described above, the image forming apparatus 4 that forms an image on the sheet P by the electrophotographic method is mentioned as an example of the image forming apparatus; however, the present invention may be applied to an inkjet recording apparatus or the like.

Although embodiments of the present invention have been described and illustrated in detail, the disclosed embodiments are made for purposes of illustration and example only and not limitation. The scope of the present invention should be interpreted by terms of the appended claims, and it goes without saying that various other application examples and modifications can be taken as long as they do not deviate from the gist of the present invention described in the claims.

For example, each of the above-described embodiments describes the configurations of the apparatus and the system in detail and concretely to explain the present invention in an easy-to-understand manner, and is not necessarily limited to those including all the described configurations. Furthermore, it is possible to replace a part of the configuration of the embodiment described here with the configuration of another embodiment, and further, it is possible to add the configuration of one embodiment to the configuration of another embodiment. Furthermore, for a part of the configuration of each embodiment, it is also possible to perform addition, deletion, or replacement of another configuration.

Furthermore, control lines and information lines indicate those that are considered necessary for explanation, and do not necessarily indicate all the control lines and information lines in a product. In practice, it may be considered that almost all configurations are connected to each other.

What is claimed is:

1. An image forming system that includes an image forming apparatus including an image former that forms an image on a recording material, the image forming system comprising:
recording material storage enabled to store the recording material;
a recording material supplier that supplies the recording material from the recording material storage to the image former;
a recording material information detection apparatus that is arranged outside the image forming apparatus and detects recording material information of the recording material; and
a hardware processor that determines whether or not the recording material detected by the recording material information detection apparatus is settable into the recording material storage on the basis of the recording material information detected by the recording material information detection apparatus and information preset for the recording material storage.

2. The image forming system according to claim 1, wherein
the hardware processor determines whether or not the recording material detected is settable into the recording material storage on the basis of the recording material information detected and a usage prohibition condition preset for the recording material storage.

3. The image forming system according to claim 2, wherein
the usage prohibition condition is set for each of sheet feeding trays included in the recording material storage.

4. The image forming system according to claim 1, wherein
the recording material information detection apparatus includes
a recording material information detector that detects recording material information of a recording material, and
a first communicator that transmits first information corresponding to the recording material information to the image forming apparatus,
the image forming apparatus includes
the image former, and
a second communicator that receives the first information from the recording material information detection apparatus, and
the hardware processor determines whether or not the recording material detected by the recording material information detector is settable into the recording material storage on the basis of a combination of the recording material information corresponding to the first information received by the second communicator and the information of the recording material storage.

5. The image forming system according to claim 1, wherein
the image forming apparatus includes a notifier that performs notification of a determination result of whether or not the recording material is settable in accordance with an instruction of the hardware processor.

6. The image forming system according to claim 5, wherein
the notifier performs notification of the information of the recording material storage for which the hardware processor determines that the recording material is settable into the recording material storage.

7. The image forming system according to claim 5, wherein
the notifier performs notification of the information of the recording material storage for which the hardware processor determines that the recording material is not settable into the recording material storage.

8. The image forming system according to claim 7, wherein
the recording material storage is provided with a locker that locks the recording material storage to prevent the recording material storage from opening, and
the hardware processor causes the locker provided for the recording material storage for which it is determined that the recording material is not settable into the recording material storage to operate to lock the recording material storage.

9. The image forming system according to claim 8, wherein
after causing the locker to operate to lock the recording material storage, the hardware processor releases locking of the recording material storage when second information different from the first information is output from the recording material information detector, or a predetermined time has elapsed.

10. The image forming system according to claim 8, wherein
the recording material storage is provided with an operation discriminator that discriminates operation performed on the recording material storage, and
the hardware processor determines whether or not the recording material detected by the recording material information detector is settable into the recording material storage on the basis of a combination of the recording material information corresponding to the first information and the information of the recording material storage on which the operation discriminated by the operation discriminator is performed.

11. The image forming system according to claim 10, wherein
the recording material storage is provided with a lever that releases locking of the recording material storage, and the operation discriminator discriminates a lever state of the lever as a content of the operation, and
the hardware processor determines whether or not the recording material detected by the recording material information detector is settable into the recording material storage on the basis of a combination of the recording material information corresponding to the first information and the information of the recording material storage from which the lever state indicating that the lever is gripped is output.

12. The image forming system according to claim 11, wherein
the recording material information includes information indicating that the recording material is a special sheet, and
when the recording material information corresponding to the first information includes information indicating that the recording material is the special sheet, the hardware processor determines whether or not the recording material detected by the recording material information detector is settable into the recording material storage on the basis of a combination with the information of the recording material storage from which the lever state indicating that the lever is gripped is output, and causes the notifier to perform notification of information indicating a setting direction of the recording material into the recording material storage for which it is determined that the recording material is settable.

13. The image forming system according to claim 11, wherein
the recording material information includes information indicating that the recording material is a special sheet, and information indicating a front surface and a back surface of the recording material, and
when the recording material information corresponding to the first information includes information indicating the special sheet and the front surface and the back surface of the recording material, the hardware processor determines whether or not the recording material detected by the recording material information detector is settable into the recording material storage on the basis of a combination with the information of the recording material storage from which the lever state indicating that the lever is gripped is output, and causes the notifier to perform notification of information indicating a setting direction of the front surface or the back surface of the recording material into the recording material storage for which it is determined that the recording material is settable.

14. The image forming system according to claim 12, wherein
the recording material storage is provided with an open and closed state discriminator that discriminates an open and closed state of the recording material storage, and
when it is discriminated by the open and closed state discriminator that the recording material storage is in an open state, the hardware processor causes the notifier to perform notification of the information indicating the setting direction of the recording material into the recording material storage for which it is determined that the recording material is settable.

15. The image forming system according to claim 1, wherein
the recording material storage is provided with a storage opener that opens the recording material storage, and
the hardware processor causes the storage opener provided for the recording material storage for which it is determined that the recording material is settable, to operate to open the recording material storage.

16. The image forming system according to claim 1, wherein
the recording material storage is provided with a dehumidifier that dehumidifies the recording material, and
when the hardware processor determines that dehumidification of the recording material is necessary on the basis of the recording material information, the hardware processor causes the notifier to perform notification of the information of the recording material storage provided with the dehumidifier.

17. The image forming system according to claim 16, wherein
the first information includes information regarding a water content of the recording material, and
when the hardware processor determines that the water content of the recording material is greater than or equal to a predetermined value on the basis of the first information, the hardware processor causes the notifier to perform notification of the information of the recording material storage provided with the dehumidifier.

18. The image forming system according to claim 16, wherein
the recording material storage is provided with a set detector that detects that the recording material is set in the recording material storage, and
the hardware processor causes the dehumidifier of the recording material storage provided with the set detector that detects that the recording material is set, to operate to dehumidify the recording material.

19. The image forming system according to claim 16, further comprising
a humidity detector that detects humidity, wherein
when the humidity detected by the humidity detector is greater than or equal to a predetermined value, the hardware processor causes the notifier to perform notification of the information of the recording material storage provided with the dehumidifier.

20. The image forming system according to claim 1, wherein
the recording material information detection apparatus detects a physical property value of the recording material as the recording material information.

21. The image forming system according to claim 1, wherein
the recording material information detection apparatus includes a recess into which a user is allowed to insert at least a part of the recording material, and detects the recording material information for the recording material inserted into the recess.

22. The image forming system according to claim 1, wherein
the recording material information detection apparatus is further arranged outside the recording material storage.

23. The image forming system according to claim 1, wherein
the recording material storage is included in the image forming apparatus.

24. The image forming system according to claim 1, wherein
the recording material storage is connected to the image forming apparatus.

25. The image forming system according to claim 1, wherein
the recording material is a sheet.

26. An image forming apparatus comprising:
an image former that forms an image on a recording material;
a recording material supplier that supplies the recording material from recording material storage in which the recording material is stored to the image former;
an acquisitor that acquires recording material information from a recording material information detection apparatus that is arranged outside the image forming apparatus and detects the recording material information of the recording material; and
a hardware processor that determines whether or not the recording material detected is settable into the recording material storage on the basis of the recording material information acquired and information preset for the recording material storage.

27. A non-transitory recording medium storing a computer readable program executed by a computer of an image forming apparatus including an image former that forms an image on a recording material,
the computer readable program causing the computer to execute:
acquiring recording material information from a recording material information detection apparatus that is arranged outside the image forming apparatus and detects the recording material information of the recording material; and
determining whether or not the recording material detected is settable into recording material storage on the basis of the recording material information acquired and information preset for the recording material storage in which the recording material is stored.
